(19) United States
(12) Patent Application Publication
(10) Pub. No.: US 2005/0199708 A1
(43) Pub. Date: Sep. 15, 2005

(54) Method for a host based smart card

(76) Inventor: Lawrence J. Friedman, Clifton Park, NY (US)

Correspondence Address: Schmeiser, Olsen & Watts LLP, Suite 201, 3 Lear Jet Lane, Latham, NY, 12110, US

(21) Appl. No.: 11/025,495

(22) Filed: Dec. 29, 2004

Related U.S. Application Data
(63) Continuation of application No. 10/796,383, filed on Mar. 9, 2004.

(51) Int. Cl. G06K 5/00; G06F 17/60

(52) U.S. Cl. 235/380; 705/38

(57) ABSTRACT

A method for a Host Based Smart (HBS) card, a method for system maintenance of the HBS card, a method for maintenance of the HBS card, and a method for purchasing goods or services using the HBS card is presented.

### CROSS-REFERENCE TO RELATED APPLICATIONS

This application is a Continuation-In-Part of copending U.S. patent application Ser. No. 10/796,383, filed on Mar. 9, 2004.

### BACKGROUND OF THE INVENTION

1. Field of Invention

The present invention generally relates to a method and system for providing a Host Based Smart (HBS) card. In particular, the present invention relates to a method and system for providing, using, and maintaining a HBS card.

2. Related Art

Methods have been developed to facilitate the use of multi-purpose cards for privileges and services at point of sale (POS) systems, specifically financial transactions. Existing multi-purpose cards attempt to incorporate some of the features and uses of debit cards, credit cards, smart cards, very smart cards, money access cards, pre-paid cards, loyalty cards, etc . . . for financial transactions into one card. A need exists for a card that can be used for any privilege or service requested by a card holder.

### SUMMARY OF THE INVENTION

The present invention provides a method related to Host Based Smart card which overcomes the aforementioned deficiencies and others inter alia provides a method and system for a HBS card that can be used for any privilege or service requested by a card holder.

One aspect of the present invention is a method for a Host Based Smart (HBS) card comprising: populating a database with a first transactional account element from a first transactional account; ascribing at least one unique modifier to said transactional account element; and ascribing a second transactional account element from a second transactional account to said unique modifier.

A second aspect of the present invention is a method of maintaining a Host Based Smart (HBS) card system comprising: managing a transactional account element of a first transactional account; and managing said first transactional account.

A third aspect of the present invention is a method for a Host Based Smart (HBS) card comprising: populating a database with a first transactional account element from a first transactional card or a first informational element from a first government issued card; ascribing at least one unique modifier to said first transactional account element or said first informational element; and ascribing a second transactional account element or a second government issued card to said unique modifier.

A fourth aspect of the present invention is a method for purchasing goods or services using a Host Based Smart (HBS) card comprising: presenting a HBS card; receiving authorization or denial for the use of said HBS card wherein at least one transactional account is available to said HBS card; providing at least one incentive to a HBS card holder; and selecting at least one said incentive.

### BRIEF DESCRIPTION OF THE DRAWINGS

The features of the present invention will best be understood from a detailed description of the invention and an embodiment thereof selected for the purpose of illustration and shown in the accompanying drawing in which:

FIG. 1A depicts a first face of a government issued card, in accordance with the present invention;

FIG. 1B depicts a second face of the government issued card, in accordance with the present invention;

FIG. 2 depicts a method for a Host Based Smart (HBS) card, in accordance with the present invention;

FIG. 3 depicts a flow chart for populating a database with informational elements, in accordance with the present invention;

FIG. 4 depicts a system view of the HBS card, in accordance with the present invention;

FIG. 5 depicts a flow chart of ascribing a unique modifier to the informational elements, in accordance with the present invention;

FIG. 6 depicts a flow chart of ascribing a transactional account to the unique modifier, in accordance with the present invention;

FIG. 7 depicts a method for system maintenance of a HBS card, in accordance with the present invention;

FIG. 8 depicts a flow chart of managing informational elements, in accordance with the present invention;

FIG. 9 depicts a flow chart of managing transactional accounts, in accordance with the present invention;

FIG. 10 depicts a method for maintenance of the HBS card, in accordance with the present invention;

FIG. 11 depicts a flow chart of managing the HBS card, in accordance with the present invention;

FIG. 12 depicts a method for purchasing goods and services using the HBS card, in accordance with the present invention;

FIG. 13 depicts a method for selling goods and services using a HBS card, in accordance with the present invention;

FIG. 14A depicts a first face of a transactional card, in accordance with the present invention;

FIG. 14B depicts a second face of the transactional card, in accordance with the present invention;

FIG. 15 depicts a second embodiment of a method for a Host Based Smart (HBS) card, in accordance with the present invention;

FIG. 16 depicts a flow chart for populating a database with transactional account elements, in accordance with the present invention;

FIG. 17 depicts a second embodiment of a system view of the HBS card, in accordance with the present invention;

FIG. 18 depicts a flow chart of ascribing a unique modifier to a first transactional account element, in accordance with the present invention;

FIG. 19 depicts a flow chart of ascribing a second transactional account to the unique modifier, in accordance with the present invention;

FIG. 20 depicts a second embodiment of a method for system maintenance of a HBS card, in accordance with the present invention;

FIG. 21 depicts a first flow chart of managing transactional account elements, in accordance with the present invention;

FIG. 22 depicts a second flow chart of managing transactional accounts, in accordance with the present invention; and

FIG. 23 depicts a second embodiment of a method for purchasing goods and services using the HBS card, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc . . . , and are disclosed simply as an example of an embodiment. The features and advantages of the present invention are illustrated in detail in the accompanying drawing, wherein like reference numeral refer to like elements throughout the drawings. Although the drawings are intended to illustrate the present invention, the drawings are not necessarily drawn to scale.

The following are definitions:

A government issued card as used herein is a card issued by a federal, a state, or a municipal government. The card issued by the federal government may include but is not limited to passports, national identification cards, military cards, social security cards, federal officer identification cards, federal employee cards, federal official cards, and the like. The card issued by the state government may include but is not limited to a driver's license, an approved non-driver identification card, a welfare card, a state officer identification card, a state employee card, a state official card, and the like. The card issued by a municipal government may include but is not limited to a municipal officer identification card, a municipal employee card, a state official card, and the like.

Informational element as used herein is an identifier of an individual that is unique to the individual. The identifier is used to recognize or establish as being a particular individual and to verify the identity of the individual. Informational elements include but are not limited to a graphic representation of an individual, a graphic representation of a fingerprint, a graphic representation of an individual's iris, a representation of an individual's DNA, an identification number, a retinal scan, and the like.

Graphic representation of an individual as used herein is a portrayal, picturing, or other rendering in a form that accurately depicts the individual being represented. Graphic representations may include but are not limited to digital photographs, laser embossed photographs, film based photographs, sketches, computer generated pictures, and the like.

Residence information as used herein is information relating to a place, such as a house or an apartment, in which a person lives or dwells. Examples include but are not limited to a street address, a state of residence, a county of residence, a borough of residence, a village of residence, and the like.

Graphic representation of a fingerprint as used herein is a portrayal, picturing, or other rendering in a form that accurately depicts the individual's fingerprint. Graphic representations may include but are not limited to digital prints, laser embossed prints, film based print, sketches of prints, computer generated prints, and the like.

Graphic representation of an individual's iris as used herein is a portrayal, picturing, or other rendering in a form that accurately depicts the individual's iris being represented. Graphic representations may include but are not limited to digital photographs, laser embossed photographs, film based photographs, sketches, computer generated pictures, and the like.

Representation of an individuals's DNA as used herein is a portrayal, picturing, or other rendering in a form that accurately depicts an individuals's DNA/molecular signature that is unique to the individual and can not be mistaken for another individual. Examples include but are not limited to samples of an individual's DNA.

Identification number as used herein is a number, an alpha-numeric number, and the like that is assigned to the government issued card for means of identifying an individual to which the government card was issued to.

Bar code as used herein is a medium of identifying patterns affixed to the government issued card that is used for storage and retrieval of informational elements. Examples include but are not limited to bar codes on government issued cards, credit cards, check cards, loyalty cards, and the like.

Magnetic stripe as used herein is a brown or black plastic-like tape that has encased within it magnetic particles of resin. Informational elements may be coded, stored, and retrieved via the arrangement of the magnetic particles. Examples include but are not limited to magnetic stripes on government issued cards, credit cards, check cards, loyalty cards, and the like

Data chip as used herein is a chip that contains a storage medium; a means to access the storage medium; a means to populate the storage medium; and a means to retrieve the informational elements.

Molecular chip as used herein is chip made of unit molecules and has dimensions on a molecular level. The chip contains a storage medium; a means to access the storage medium; a means to populate the storage medium; and a means to retrieve the informational elements.

A unique modifier as used herein is an identifier that is unique and can not be mistaken for another identifier. Examples include of but not limited to alpha characters, numeric characters, alpha-numeric characters, and the like.

Transactional account as used herein is an accommodation or service extended by an institution to a customer or client permitting the use of the accommodation or service towards goods or services. Examples of transactional accounts include but are not limited to a credit card, a checking account, a debit card, a loyalty card, a membership card, and the like.

Internal Host as used herein is a computer system containing data, programs, databases, data transmission networks, and combinations thereof that can communicate with and access other computer systems with permission of the computer system and can be accessed by other computer systems with permission of the Internal Host.

An External Authorizing host as used herein is a computer system containing data, programs, databases, data transmission networks, and combinations thereof that can access other computer systems with the permission of the computer system and can be accessed by other computer systems with the permission of the External Authorizing Host. Examples include but are not limited to U.S. banks or international banks, the U.S. Treasury Department's Office of Foreign Asset Control, the Internal Revenue Service, the Department of Homeland Security, credit unions, consumer credit monitoring agencies, and the like.

An electronic peripheral as used herein is a device that can read a card having informational elements stored on the card and obtain the informational elements encoded. Examples included but are not limited to a scanner, a radio frequency reader, wireless devices, voice recognition devices, point of sales (POS) systems, and the like.

A POS system is a sales, marketing, and inventory management system where financial transactions take place. A POS system is composed of the following and combinations thereof: a computer, software, electronically controlled cash drawer, a receipt printer, a bar code scanning device, a magnetic card reading device, a check reading device, hardware and software for Internet access and communication, and a customer display. Examples include but are not limited to POS systems at retail stores, hospitals, restaurants, drinking establishments, gas stations, e-commerce business, wholesale distribution outlets, and the like.

Data transmission network as used herein is a system containing computers, computer terminals, printers, audio or visual display devices, servers or telephones and wireless devices interconnected by telecommunication equipment or cables used to transmit or receive information and combinations thereof.

Server as used herein is a computer system that makes services, as access to data files, programs, and peripheral devices, available to workstations or other computer systems on a network.

Goods and services as used herein are products, merchandise, benefits, features, advantages, assistance, and rights granted by a provider of the goods and services. Examples of goods include but are not limited to food, clothing, shelter, automobiles, toys, and the like. Examples of services include but are limited to electronic fund transactions, credit card transactions, debit card transactions, money access card transactions, loyalty card transactions, AAA membership, repair services, insurance, and the like.

Customer Segmentation as used herein is the practice of dividing a customer base into groups of individuals that are similar in specific ways relevant to marketing, such as age, gender, interests, spending habits, and the like. Spending habits of customers are often rated based upon the frequency of usage and the average dollars transacted per usage. Value-based segmentation looks at groups of customers in terms of the revenue they generate and the costs of establishing and maintaining relationships with them. Examples of value-based segmentation categories include but are not limited to a platinum status, a gold status, a silver status, a blue status, and the like.

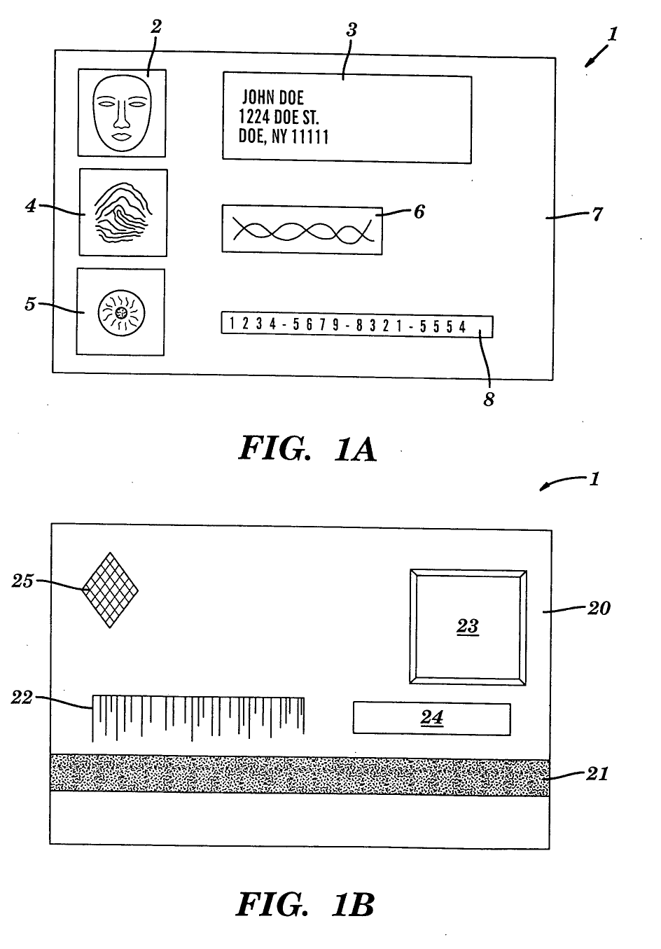

FIG. 1A depicts a first face 7 of a government issued card 1 comprising informational elements: a graphic representation of an individual 2; a residence information 3; a graphic representation of a fingerprint 4; a graphic representation of an individual's iris 5; a representation of an individual's DNA 6, and an identification number 8.

FIG. 1B depicts a second face 20 of a government issued card 1 comprising: a magnetic stripe 21, a bar code 22, a data chip 23, a molecular chip 24, and a retinal scan 25.

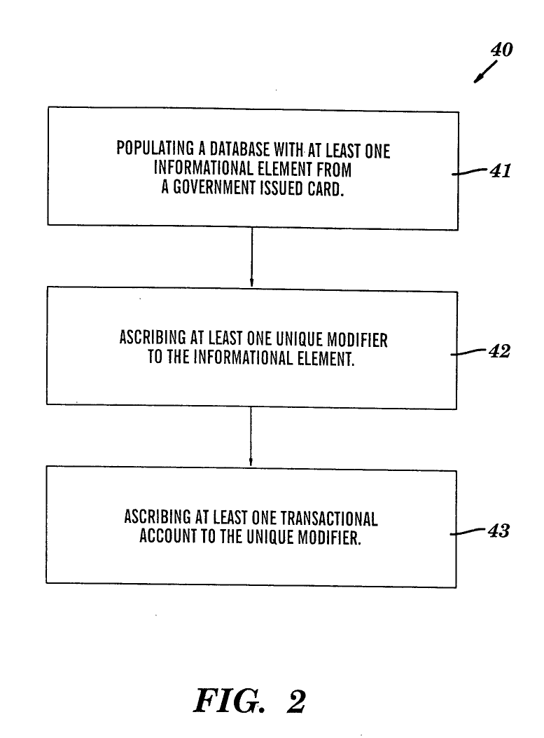

FIG. 2 depicts an embodiment of the present invention, a method 40 for a Host Based Smart (HBS) card comprising: a step 41, populating a database with at least one informational element from a government issued card; a step 42, ascribing at least one unique modifier to the informational element; and a step 43, ascribing at least one transactional account to the unique modifier.

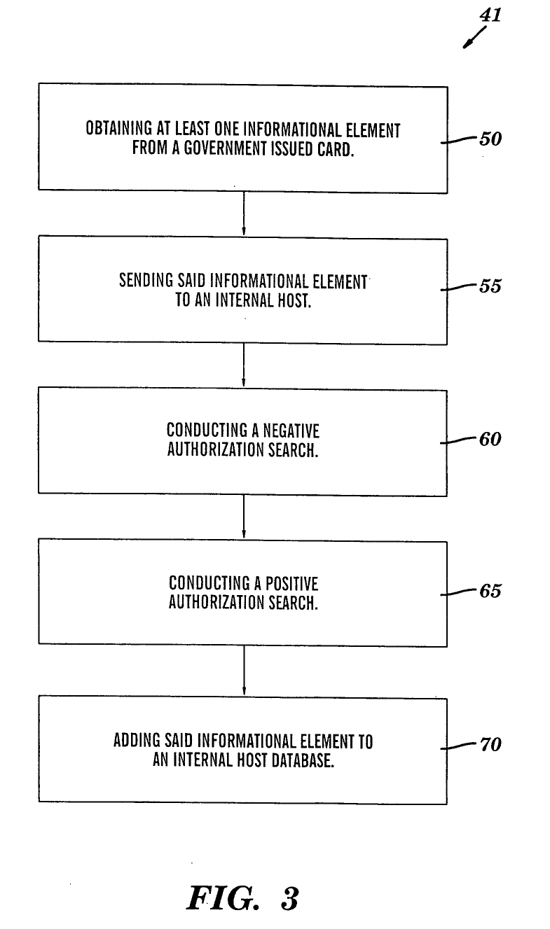

FIG. 3 depicts a flow chart of the step 41, populating a database with informational elements from a government issued card 1, of the method 40 of FIG. 2. Step 41 further comprises: a step 50, obtaining at least one informational element from a government issued card 1; a step 55, sending the informational element to an Internal Host; a step 60, conducting a negative authorization search; a step 65, conducting a positive authorization search; and a step 70, adding at least one informational element to an Internal Host Database.

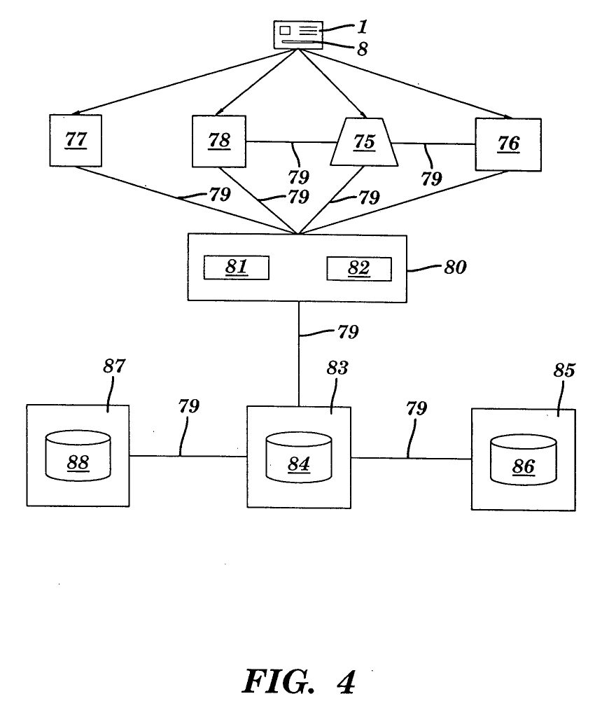

FIG. 4 depicts a system view of an embodiment of the present invention. As shown in FIG. 3 and FIG. 4, a step 41 of the method 40, one embodiment of the present invention focuses on populating a database with informational elements from a government issued card 1, wherein the card 1 is a state issued driver's license or approved-non driver identification and the informational element is an identification number 8.

As shown in FIG. 3 and FIG. 4, the step 50, obtaining the informational element from a government issued card 1, of the step 41, the government issued card 1 may be inserted into an electronic peripheral 75. The electronic peripheral 75 reads the magnetic stripe 21 or the bar code 22 on the government issued card 1 to obtain the informational element, i.e. the number 8. The electronic peripheral 75 may also scan and capture the graphical representation of the individual 2 of the government issued card 1 as well as capture a graphical representation of the entire card 1.

Alternatively, it can be envisioned where the government issued card 1 may have a data chip 23 imbedded within the body of the card 1 It is envisioned where the data chip 23 may contain informational elements such as the graphic representation of an individual 2; the residence information 3; the graphic representation of a fingerprint 4; the graphic representation of an individual's iris 5; the representation of an individual's DNA 6, the identification number 8, and the like. The data chip 23 may be read by an electronic peripheral 75 and similar devices.

Alternatively, obtaining informational elements from a government issued card 1 may be accomplished via a radio frequency (RF) reader 76. An individual may pass their government issued card 1 over a RF reader 76 which uses a RF transponder to activate the data chip 23 within the card 1. Informational elements such as the graphic representation of an individual 2; the residence information 3; the graphic representation of a fingerprint 4; the graphic representation of an individual's iris 5; the representation of an individual's DNA 6, the identification number 8, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots®, Handspring Visor®, Handspring Treo®; and the like can be used to obtain the informational elements. Such devices could obtain the informational elements via scanning technology used to read the magnetic strip 21 or bar code 23, or have said informational elements manually inputted into said devices via physical or virtual keyboards.

Alternatively, one can obtain informational elements like the identification number 8, the address information 3, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The informational elements obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79. Alternatively, for smaller companies and businesses, the Internal Host 83 may also function as the off-site server 82 as well as function as the Internal Host simultaneously.

As shown in FIG. 3 and FIG. 4 for points of illustration; the step 55, sending the informational element to an Internal Host 83, of the step 41, the informational element obtained via step 50 is temporarily stored in the server 80, local 81 or off-site 82, may be sent to the Internal Host 83 from the server 80. The server 80 then sends the informational element, the identification number 8, to the Internal Host 83 via data transmission networks 79 wherein the informational element is stored in an Internal Host database 84.

As shown in FIG. 3 and FIG. 4 for points of illustration; the step 60, conducting a negative authorization search, of the step 41, the Internal Host 83 may conduct a negative authorization search of the Internal Host database 84 by searching for a duplicate match of the identification number 8 or a match of the identification number 8 in a negative file. The negative file is a file that contains a transaction history of the individual that indicates whether the individual has unresolved financial issues that would not make them preferable for use of or membership to a HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the identification number 8 submitted. If a match is found, the step method 40 is terminated and the identification number 8 is placed in a negative file located in the Internal Host database 84. If a negative authorization search does not find a duplicate match or a match in a negative file, the method 40 is allowed to continue.

As shown in FIG. 3 and FIG. 4 for points of illustration; the step 65, conducting a positive authorization search, of the step 41, the Internal Host 83 sends the identification number 8 of the government issued card 1 to another External Authorizing Host 87 for a positive authorization search. The External Authorizing Host 87 used for a positive authorization search is one that maintains secure information relating to informational elements and personal information of a government issued card 1. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the identification number 8 submitted. If the External Authorizing Host 87 finds a match, the host then will send back to the Internal Host 83 informational elements on file in the External Authorizing Host database 88 that correspond to the identification number 8 as well as any personal information that would potentially place the person submitted in a negative file on the Internal Host database 83. This information may include but is not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the method 40 and place the identification number 8 in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to the identification number 8 submitted, the External Authorizing Host 88 will send a file not found notification to the Internal Host 83. The Internal Host 83 will then terminate the method 1 and place identification number 8 in a negative file.

As shown in FIG. 3 and FIG. 4 for points of illustration; the step 70, adding said informational elements to the Internal Host database 84, of the step 41, if a negative authorization search, of the step 60, yields no matches and a positive authorization search, of the step 65, yields a match with no red flag information, the Internal Host 83 then adds the informational elements to the Internal Host database 84. The informational element is stored as the identification number 8 of the government card 1, specifically the state issued driver's license number or an approved non-driver identification number.

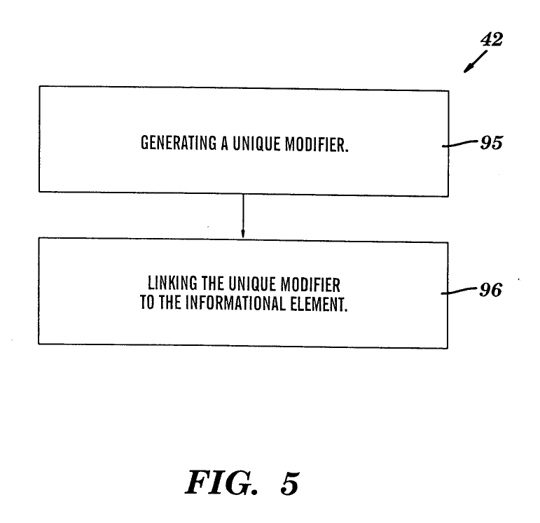

FIG. 5 depicts the step 42, ascribing at least one unique modifier to the informational element, of the method 40 of FIG. 1. Step 42 further comprises: a step 95, generating a unique modifier; and a step 96, linking the unique modifier to the informational element. In an embodiment of the present, the informational element is a government issued card 1 identification number 8; specifically the state issued driver's license number or approved non-driver identification number. As shown in FIG. 4 and FIG. 5, the step 95, generating a unique modifier, the Internal Host 83 generates a unique modifier via computer science methodology. The methodologies may include but art not limited to off-the-shelf retail software, in-house proprietary software, and the like. The unique modifiers generated may be numerical, alphabetic, symbolic, alpha-numeric, and the like as well as combinations thereof.

As shown in FIG. 4 and FIG. 5, the step 96, linking the unique modifier to the informational element, the Internal Host 83 links the unique modifier generated in the step 95 to the informational element via computer science methodology. The methodologies may include but art not limited to off-the-shelf retail software, in-house proprietary software, and the like as well as combinations thereof. The informational elements used are elements that have been previously populated in the Internal Host database 84 by the step 41 of the method 40. The result of the steps 95 and 96 is an informational element having a unique modifier ascribed to the informational element.

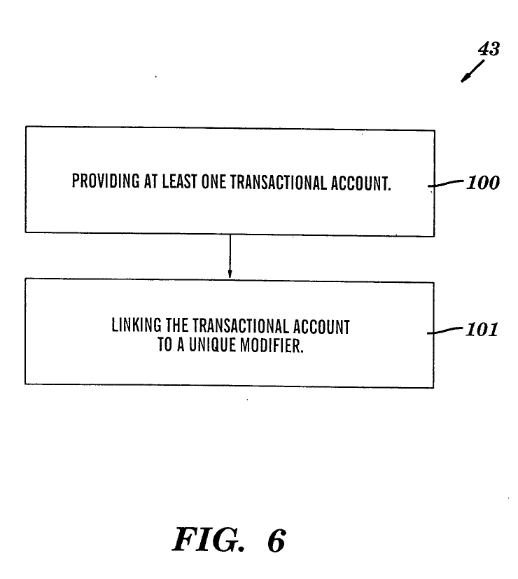

FIG. 6 depicts the step 43, ascribing at least one transactional account to the unique modifier, of the method 40 of FIG. 2. Step 43 further comprises: a step 100, providing the transactional account; and a step 101, linking the transactional account to the unique modifier of step 42 of the method 40.

As shown in FIG. 4 and FIG. 6, the step 100, one embodiment of the present invention focuses on providing the transactional account wherein the transactional account is a checking account. A check may be inserted into an electronic peripheral 75. The electronic peripheral 75 reads a Magnetic Ink Character Recognition (MICR) of the check to obtain account information, such as a routing number, the checking account number, and the check number. The electronic peripheral 75 may also scan and capture a graphical representation of the check.

Alternatively, it can be envisioned where the check may have a data chip 23 imbedded within the body of the check. It is envisioned where the data chip 23 may contain account information such as the graphic representation of the check; the routing number; the checking account number; the check number, and the like. The data chip 23 may be read by an electronic peripheral 75 or similar devices.

Alternatively, obtaining checking information from a check may be accomplished via a radio frequency (RF) reader 76. An individual may pass their check over a RF reader 76 which uses a RF transponder to activate the data chip 23 within the card 1. Checking account information such as the graphic representation of the check; the routing number; the checking account number; the check number, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots®, Handspring Visor®, Handspring Treo®; and the like can be used to provide checking account information. Such devices could provide the account information via scanning technology used to read the MICR, or have the MICR manually inputted into said devices via physical or virtual keyboards.

Alternatively, one can provide checking account information such as the routing number; the checking account number, the check number, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The checking account information obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79.

The checking account information provided is temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84.

The Internal Host 83 may conduct a negative authorization search of the Internal Host database 84 by searching for a duplicate match of the checking account information or a match in a negative file. The negative file is a file that contains a transaction history of the individual that indicates whether the individual has unresolved financial issues that would not make them preferable for use of or membership to the HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the checking account number submitted. If a match is found, the step 43 is terminated and the account number is placed in a negative file located in the Internal Host database 84. If a negative authorization search does not find a duplicate match or a match in a negative file, the step 43 is allowed to continue.

The Internal Host 83 sends the account information to another External Authorizing Host 87 for a positive authorization search. The External Authorizing Host 87 used for a positive authorization search is one that maintains secure information relating to transactional accounts and personal information related to the account. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the account number submitted. If the External Authorizing Host 87 finds a match, the host then will send back to the Internal Host 83 account information on file in the External Authorizing Host database 88 that correspond to the account number as well as any personal information that would place the person submitted in a negative file on the Internal Host database 83. This information may include but is not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the step 43 and place the checking account number in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to checking account number submitted, the External Authorizing Host 88 will send a file not found notification to the Internal Host 83. The Internal Host 83 will then terminate the step 43 and place the account number in a negative file. If a negative authorization search yields no matches and a positive authorization search yields a match with no red flag information, the Internal Host 83 then provides the checking account information to the Internal Host database 84.

As shown in FIG. 4 and FIG. 6, the step 101, one embodiment of the present invention focuses on linking the transactional account to a unique modifier wherein the transactional account is a checking account. The Internal Host 83 links the checking account number to the unique modifier previously ascribed to an informational element that was used to populate the Internal Host Database 84 of the step 41 of the method 40.

The linking is accomplished via computer science methodology. The methodologies may include but art not limited to off-the-shelf retail software, in-house proprietary software, and the like. The transactional account will be now ascribed to the informational element via the unique modifier and stored in the Internal Host database 84.

The results of the step 41, the step 42, and the step 43 of the method 40 is a government issued card 1, specifically the state issued driver's license or the approved non-driver identification card that is now effectively equivalent to a checking account and is afforded any associated checking privileges, i.e. a HBS card, through the method of having the checking account ascribed to the state issued driver's license or the approved non-driver identification number via the unique modifier. The state issued driver's license or the approved non-driver identification card can be used for limited check cashing privileges until a positive check cashing history has been achieved. Once the checking account has been ascribed to the state issued driver's license or the approved non-driver identification via the modifier, an individual no longer is required to present a check for checking privileges.

Limited check cashing privileges entail check velocity and check amount limits per week. For example, 2-3 checks may be written for the first three weeks without the aggregate sum not exceeding $300 per week. The second three weeks may include 3-5 checks without the aggregate sum not exceeding $600. Any number of variations of check velocity and check amount limits can be envisioned for developing a positive check cashing history. The more positive a customer's check cashing history is, the greater the check velocity and check amount limits can be.

Alternatively, a transactional account such as a credit card may also be linked to the unique modifier as well as debit cards, loyalty cards, retail cards, membership cards, and the like. Once the transactional accounts of the aforementioned cards have been linked to the government issued card 1, the cards are no longer required to be presented for the use of services and privileges associated.

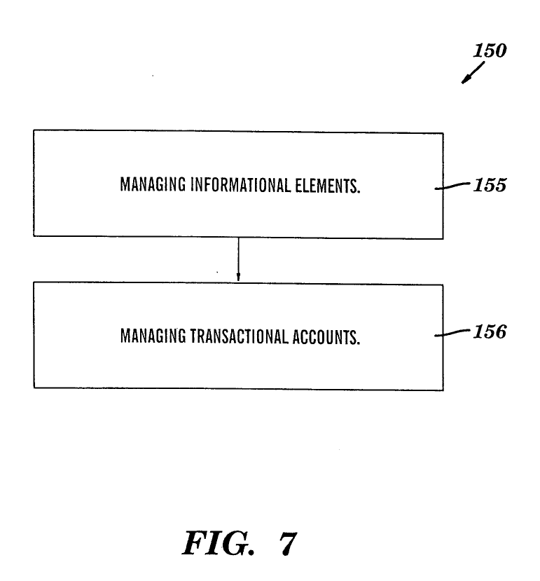

FIG. 7 depicts an embodiment of the present invention, a method 150 for system maintenance of a Host Based Smart (HBS) card comprising: a step 155, managing informational elements; and a step 156 managing transactional accounts.

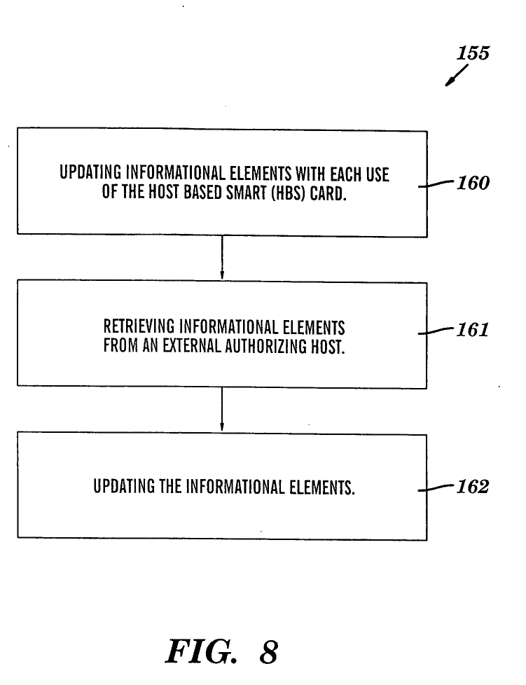

FIG. 8 depicts a flow chart of the step 155, managing informational elements, of the method 150. The step 155 further comprises: a step 160, updating informational elements with each use of the HBS card; a step 161, retrieving informational elements from an external authorizing host; and a step 162, updating the informational elements.

As shown in FIG. 4 and FIG. 8, the step 160, one embodiment of the present invention focuses on updating informational elements with each use of the HBS card, wherein the card is a state issued driver's license or approved non-driver identification card. Each time the HBS card is inserted into an electronic peripheral 75. The electronic peripheral 75 reads the magnetic stripe 21 or bar code 22 on the HBS card to obtain the informational elements encoded in the magnetic. The electronic peripheral 75 also scans and captures the informational elements on the HBS card.

In an alternative embodiment, it can be envisioned where the HBS card may have a data chip 23 imbedded within the body of the HBS card. The data chip 23 would contain informational elements such as the graphic representation of an individual 2; the residence information 3; the graphic representation of a fingerprint 4; the graphic representation of an individual's iris 5; the representation of an individual's DNA 6, the identification number 8, and the like. The chips may be read by an electronic peripheral 75 and similar devices.

In an alternative embodiment, obtaining informational elements from a HBS card may be accomplished via a radio frequency (RF) reader 76. An individual may pass their HBS card over a RF reader 76 which uses a RF transponder to activate the data chip within said HBS card. The informational elements of the HBS card would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 76.

In an alternative embodiment, it can be envisioned that obtaining informational elements from a HBS card may be accomplished via wireless devices 77 such as cell phones; PDAs such as Palm Pilots®, Handspring Visor®, Handspring Treo®; and the like. Such devices would obtain the informational elements via scanning technology or have the informational elements obtained via manually inputting the informational elements into the devices via physical or virtual keyboards.

In an alternative embodiment, informational elements may be obtained via voice recognition technology. Current voice recognition software and voice recognition devices 78 are able to transcribe voice into text for use by an electronic peripheral 75. The voice recognition devices 78 may be a stand alone unit that is connected to the electronic peripheral 75 via data transmission networks 79 or may be part of the electronic peripheral 75.

The informational elements obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79 may be temporarily stored in servers 17 connected to the aforementioned devices. The servers may be a local server 81, such as a POS or in-store server, or an off-site server 82, such as a retail headquarter or chain headquarter server, that is off-site but connected to the electronic peripheral 75, voice recognition devices 78, wireless devices 77, and RF readers 76 via data transmission networks 79.

The informational elements provided are temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84.

The Internal Host 83 may conduct a negative authorization search of the Internal Host database 84 by searching for a duplicate match of the checking account information or a match in a negative file. The negative file is a file that contains a transaction history of the individual that indicates whether the individual has unresolved financial issues that would not make them preferable for use of or membership to a HBS card. The informational elements just obtained are compared to informational elements previously used to populate the Internal Host database 84, of the step 41 of the method 40 of FIG. 2.

If the Internal Host 83 identifies any differences between the two sets of informational elements or discovers a new informational element that was not previously used to populate the Internal Host database 84, the Internal Host 83 will replace any old informational elements on the Internal Host database 84 with the new informational elements or add new informational elements to the Internal Host database 84 that were not previously used to populate the Internal Host database 84.

As shown in FIG. 4 and FIG. 8, a step 161, retrieving informational elements from an External Authorizing Host 22, of the step 155 of the method 150, an embodiment of the present invention focuses on retrieving informational elements from an External Authorizing Host 84 wherein the informational element is a state issued driver's license or approved-non driver identification number of the HBS card.

The Internal Host 84 may randomly; on a predetermine schedule; by command of an Internal Host administrator; or with each use of the HBS card retrieve informational elements from an External Authorizing Host 87. The Internal Host 83 contacts the External Authorizing Host 87 via the data transmission network 79. The Internal Host 83 then sends the HBS card number to the External Authorizing Host 88 for a positive authorization search. The External Authorizing Host 88 used is one that maintains secure information relating to informational elements and personal information of an individual. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches within the External Host database 88 for a positive match to the HBS card number submitted. If the External Authorizing Host 88 finds a match, the host 88 then sends back to the Internal Host 84 informational elements that correspond to the HBS card number.

As shown in FIG. 4 and FIG. 8, a step 162, updating informational elements from an External Authorizing Host 88, of the step 155 of the method 150. The informational elements retrieved, of the step 161, are compared to informational elements previously used to populate the Internal Host database 84, of the step 41 of the method 40 of FIG. 2.

If the Internal Host 83 identifies any differences between the two sets of informational elements or identifies a new informational element that was not previously used to populate the Internal Host database 84, the Internal Host 83 will replace any old informational elements on the Internal Host database 84 with the new informational elements or add new informational elements, submitted by the External Authorizing Host 87, in the Internal Host database 84 that were not previously used to populate the Internal Host database 84.

Updated informational elements of the HBS card pertaining to red flag information in nature may place the HBS card in a negative file on the Internal Host's database 84. This information may include but is not limited to red flag information such as a stolen driver's license, an illegal alien, a terrorist suspect, an international fugitive, a domestic fugitive, a member of the F.B.I. top ten wanted list and the like.

All red flag information associated with the HBS card and related to national security will automatically create an exception file in the Internal Host database. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

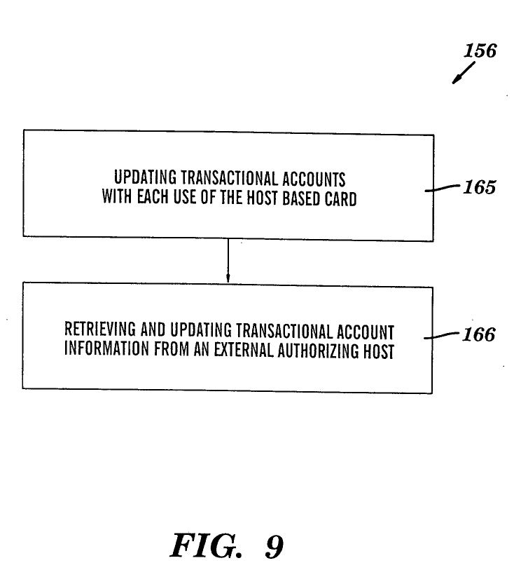

FIG. 9 depicts a flow chart of the step 156, managing transactional accounts, of the method 150. The step 156 further comprises: a step 165, updating updating transactional account information with each use of the HBS card; and a step 166, retrieving and updating transactional account information from the External Authorizing Host.

As shown in FIG. 4 and FIG. 9; a step 165, updating updating transactional account information with each use of the HBS card, one embodiment of the present invention focuses on updating transactional account information wherein the transactional account is a checking account.

Each time the HBS card is inserted into an electronic peripheral 75. The electronic peripheral 75 reads the magnetic stripe 21 or bar code 22 on the HBS card to obtain the informational elements encoded in the magnetic. The electronic peripheral 75 also scans and captures the informational elements on the HBS card.

The informational elements obtained are temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79 may be temporarily stored in a server 80 connected to the aforementioned devices. The server 80 may be a local server 81, such as a POS or in-store server, or an off-site server 82, such as a retail headquarter or chain headquarter server, that are off-site but connected to the electronic peripheral 75, voice recognition devices 78, wireless devices 77, and RF readers 76 via data transmission networks 79.

The informational elements provided are temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84. The Internal Host 20 examines the aforementioned information element and identifies the unique modifier that has been ascribed to it. Subsequently, all transactional accounts linked to the unique modifier are able to be identified. In this example, the checking account to be updated is identified.

The Internal Host 83 then conducts a negative search of the Internal Host database 84 by searching for a duplicate match of the checking account or a match of the checking account in a negative file. The negative file is a file that contains a transaction history of the consumer that indicates whether the consumer has unresolved financial issues that would not make them preferable for use of or membership to a HBS card. If a match is found, the use of the HBS card as a checking transaction is terminated and the checking account linked to the HBS card is placed in a negative file located in the Internal Host database 84. If a negative search does not find a duplicate match or a match in a negative file, the use of the HBS card for checking services and privileges remain.

As shown in FIG. 4 and FIG. 9; the step 166, retrieving and updating transactional accounts from an External Host, of the step 156 of the method 150, one embodiment of the present invention focuses on updating transactional accounts wherein the transactional account is a checking account.

The Internal Host 83 may randomly, on a predetermine schedule, by command of an Internal Host administrator, or automatically with each use of the HBS card update transactional account information from the External Authorizing Host 85. The Internal Host 83 contacts the External Authorizing Host 85 via the data transmission network. The Internal Host 83 then sends the account number of the checking account to the External Authorizing Host 85 for a negative search. The External Authorizing Host 85 then looks within the External Host database 86 for a match in a negative file that may not be in the Internal Host database 84.

The External Authorizing Host 85 that is used for a negative search may be an institution that offers credit cards, debt cards, checking privileges, or any services related to financial transactions; and that keeps records of said financial transactions. Examples of such institutions include but are not limited to U.S. banks or international banks, the U.S. Treasury Department's Office of Foreign Asset Control, the Internal Revenue Service, the Department of Homeland Security, credit unions, consumer credit monitoring agencies, and the like.

The External Authorizing Host 85 searches within the External Host database 86 for a match, in a negative file, to the account number of the checking account submitted. If a match is found, the checking account that is linked to the HBS card is placed in a negative file located in the Internal Host database 84, and the negative file is sent to the requesting server. If a negative search does not find a duplicate match or a match in a negative file, no updates are made to the transactional account.

The above example of the transactional account that was updated from an External Authorizing Host 86 was a a checking account. Alternative transaction accounts that may be updated from an External Authorizing Host 86 may include but are not limited to credit cards, debit cards, money management cards, and the like.

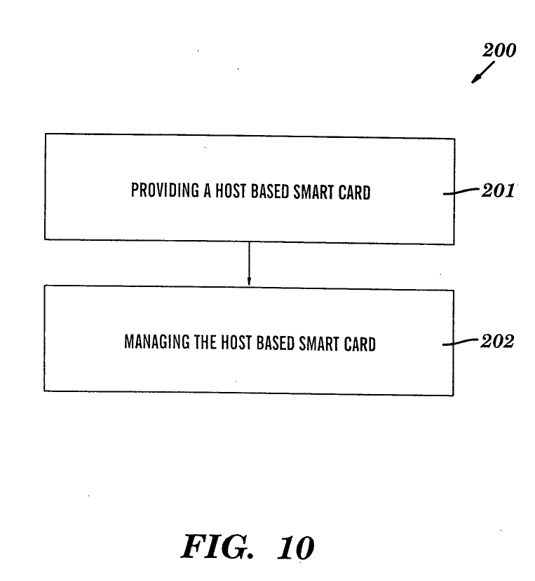

FIG. 10 depicts an embodiment of the present invention, method 200, for maintenance of a Host Based Smart (HBS) card comprising: a step 201, providing the HBS card; and a step 202, managing the HBS card.

As shown in FIG. 2 and FIG. 10, the step 201 of the method 200, one embodiment of the present invention focuses on providing a HBS card wherein the HBS card was arrived at from the method 40: the step 41, populating a database with at least one informational element from the government issued card; the step 42, ascribing at least one unique modifier to the informational element; and the step 43, ascribing at least one transactional account to the unique modifier.

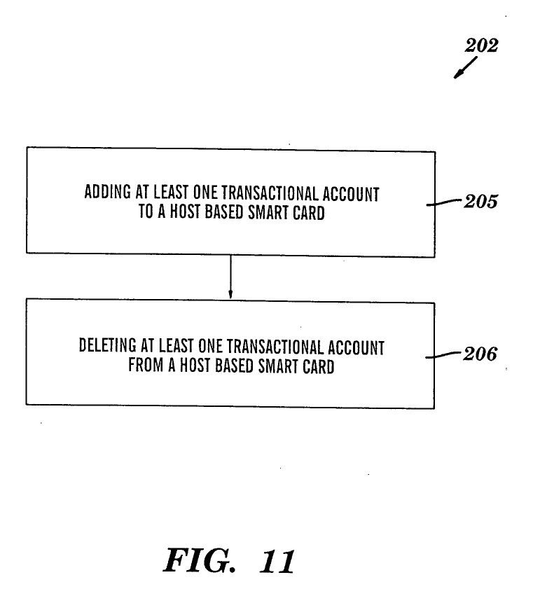

FIG. 11 depicts a flow chart of the step 202, managing the Host Based Smart (HBS) card, of the step 200 of the method 200 of FIG. 10. The step 202, further comprises: a step 205, adding transactional accounts; and a step 206, deleting transactional accounts. As shown in FIG. 4 and FIG. 11, the step 205, an embodiment of the present invention focuses on adding transactional accounts to the HBS card.

A HBS cardholder approaches the electronic peripheral 75 to add a transactional account. In this example, the transactional account to be added is a checking account. The cardholder inserts their HBS card into an electronic peripheral 75. The electronic peripheral 75 reads the HBS card and obtains the informational elements from the card. The cardholder then inputs their PIN and then receives a prompt asking what they would like to do: add a new transactional account, delete a transactional account, or access current HBS account information.

Alternatively, the HBS card may be read via a radio frequency (RF) reader 76. The cardholder may pass their HBS card over a RF reader 76 which uses a RF transponder to activate the data chip 23 within the card. Informational elements such as the graphic representation of an individual 2; the residence information 3; the graphic representation of a fingerprint 4; the graphic representation of an individual's iris 5; the representation of an individual's DNA 6, the identification number 8, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots®, Handspring Visor®, Handspring Treo®; and the like can be used to read the HBS card. Such devices could obtain the informational elements via scanning technology used to read the magnetic strip 21 or bar code 23, or have the informational elements manually inputted into said devices via physical or virtual keyboards.

Alternatively, one can obtain informational elements like the identification number 8, the address information 3, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The informational elements obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79.

The electronic peripheral 75 further prompts the cardholder: what kind of transactional account would they like to add—personal checking services, credit card services, debit card services, loyalty card services, and the like. The informational elements obtained are temporarily stored in the server 80, local 81 or off-site 82, may be sent to the Internal Host 83 from the server 80. The server 80 then sends the informational element, the identification number 8, to the Internal Host 83 via data transmission networks 79 wherein the informational element is stored in an Internal Host database 84.

The Internal Host 83 then conducts a negative authorization search of the Internal Host database 84 by searching for a duplicate match of the identification number 8 or a match of the identification number 8 in a negative file. The negative file is a file that contains a transaction history of the individual that indicates whether the individual has unresolved financial issues that would not make them preferable for use of or membership to a HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the identification number 8 submitted. If a match is found, the step method 40 is terminated and the identification number 8 is placed in a negative file located in the Internal Host database 84. If a negative authorization search does not find a duplicate match or a match in a negative file, the method 200 is allowed to continue.

The Internal Host 83 sends the identification number 8 of the HBS card to the External Authorizing Host 87 for a positive authorization search. The External Authorizing Host 87 used for a positive authorization search is one that maintains secure information relating to informational elements and personal information of the HBS card. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the identification number 8 submitted. If the External Authorizing Host 87 finds a match, the host then will send back to the Internal Host 83 informational elements on file in the External Authorizing Host database 88 that correspond to the identification number 8 as well as any personal information that would place the person submitted in a negative file on the Internal Host database 83. This information may include but is not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the method 40 and place the identification number 8 in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to the identification number 8 submitted, the External Authorizing Host 88 will send a file not found notification to the Internal Host 83. The Internal Host 83 will then terminate the method 200 and place identification number 8 of the HBS card in a negative file.

If a negative authorization search yields no matches and a positive authorization yields a match with no red flag information, the electronic peripheral then prompts the cardholder for the transactional account information to be added to the HBS card. In this example, a checking account number.

The electronic peripheral 75 reads a MICR of the check to obtain account information, such as a routing number, the checking account number, and the check number. The electronic peripheral 75 may also scan and capture a graphical representation of the check.

Alternatively, it can be envisioned where the check may have a data chip 23 imbedded within the body of the check. It is envisioned where the data chip 23 may contain account information such as the graphic representation of the check; the routing number; the checking account number; the check number, and the like. The data chip 23 may be read by an electronic peripheral 75 or similar devices.

Alternatively, obtaining checking information from a check may be accomplished via a radio frequency (RF) reader 76. An individual may pass their check over a RF reader 76 which uses a RF transponder to activate the data chip 23 within the card 1. Checking account information such as the graphic representation of the check; the routing number; the checking account number; the check number, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots™, Handspring Visor™, Handspring Treo™; and the like can be used to provide checking account information. Such devices could provide the account information via scanning technology used to read the MICR, or have the MICR manually inputted into said devices via physical or virtual keyboards.

Alternatively, one can provide checking account information such as the routing number; the checking account number, the check number, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The checking account information obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79.

The checking account information provided is temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84.

The Internal Host 83 may conduct a negative authorization search of the Internal Host database 84 by searching for a duplicate match of the checking account information or a match in a negative file. The negative file is a file that contains a transaction history of the individual that indicates whether the individual has unresolved financial issues that would not make them preferable for use of or membership to a HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the checking account number submitted. If a match is found, the step 43 is terminated and the account number is placed in a negative file located in the Internal Host database 84. If a negative authorization search does not find a duplicate match or a match in a negative file, the step 43 is allowed to continue.

The Internal Host 83 sends the account information to another External Authorizing Host 87 for a positive authorization search. The External Authorizing Host 87 used for a positive authorization search is one that maintains secure information relating to transactional accounts and personal information related to the account. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the account number submitted. If the External Authorizing Host 87 finds a match, the host then will send back to the Internal Host 83 account information on file in the External Authorizing Host database 88 that correspond to the account number as well as any personal information that would place the person submitted in a negative file on the Internal Host database 83. This information may include but is not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the step 43 and place the checking account number in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to checking account number submitted, the External Authorizing Host 88 will send a file not found notification to the Internal Host 83. The Internal Host 83 will then terminate the step 205 and place the account number in a negative file. If a negative authorization search yields no matches and a positive authorization search yields a match with no red flag information, the Internal Host 83 then provides the checking account information to the Internal Host database 84.

Internal Host 83 then generates a unique modifier via computer science methodology. The methodologies may include but art not limited to off-the-shelf retail software, in-house proprietary software, and the like. The unique modifiers generated may be numerical, alphabetic, symbolic, alpha-numeric, and the like as well as combinations thereof. The Internal Host 83 links the unique modifier generated to the informational element via computer science methodology. The methodologies may include but art not limited to off-the-shelf retail software, in-house proprietary software, and the like as well as combinations thereof. The informational elements used are elements that have been previously populated in the Internal Host database 84 by the step 41 of the method 40. The result of the steps 95 and 96 is an informational element having a unique modifier ascribed to the informational element.

The Internal Host 83 links the checking account number to the unique modifier previously ascribed to an informational element that was used to populate the Internal Host Database 84.

The linking of the checking account number to the unique modifier is accomplished via computer science methodology. The methodologies may include but art not limited to off-the-shelf retail software, in-house proprietary software, and the like. The checking account will be now linked to the informational element via the unique modifier and stored in the Internal Host database 84.

The result is the HBS card that is now effectively equivalent to a checking account and is afforded any associated checking privileges, through the method 200, providing the HBS card and managing the HBS card. The HBS card can be used for limited check cashing privileges until a positive check cashing history has been achieved. The physical presentation of a check is no longer required for checking services and privileges.

Limited check cashing privileges entail check velocity and check amount limits per week. For example, 2-3 checks may be written for the first three weeks without the aggregate sum not exceeding $300 per week. The second three weeks may include 3-5 checks without the aggregate sum not exceeding $600. Any number of variations of check velocity and check amount limits can be envisioned for developing a positive check cashing history. The more positive a customer's check cashing history is, the greater the check velocity and check amount limits can be.

Alternatively, other transactional accounts such as a credit card may also be added to the HBS card as well as debit cards, loyalty cards, retail cards, membership cards, and the like.

Referring to FIG. 11, the step 206, deleting transactional accounts, as shown in FIG. 4 and FIG. 11, the step 206, an embodiment of the present invention focuses on deleting transactional accounts from the HBS card. A HBS cardholder approaches the electronic peripheral 75 to delete a transactional account. In this example, the transactional account to be deleted is a checking account. The cardholder inserts their HBS card into an electronic peripheral 75. The electronic peripheral 75 reads the HBS card and obtains the informational elements from the card. The cardholder then inputs their PIN and then receives a prompt asking what they would like to do: add a new transactional account, delete a transactional account, or access current HBS account information.

Alternatively, the HBS card may be read via a radio frequency (RF) reader 76, wireless devices 77, and voice recognition devices 78.

The informational elements obtained by the electronic peripheral 75, the RF reader 76, wireless devices 77, and the voice recognition devices 78 may be temporarily stored in a server 80 connected to the aforementioned devices via data transmission networks 79. The informational elements obtained that were temporarily stored in the server 80, local 81 or off-site 82, may be sent to the Internal Host 83 from the server 80. The server 80 then sends the informational element, the identification number 8, to the Internal Host 83 via data transmission networks 79 wherein the informational element is stored in an Internal Host database 84.

The Internal Host 83 then conducts a negative authorization search of the Internal Host database 84 by searching for a duplicate match of the identification number 8 or a match of the identification number 8 in a negative file. The negative file is a file that contains a transaction history of the individual that indicates whether the individual has unresolved financial issues that would not make them preferable for use of or membership to a HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactionactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the identification number 8 submitted. If a match is found, the step method 40 is terminated and the identification number 8 is placed in a negative file located in the Internal Host database 84. If a negative authorization search does not find a duplicate match or a match in a negative file, the method 200 is allowed to continue.

The Internal Host 83 sends the identification number 8 of the HBS card to the External Authorizing Host 87 for a positive authorization search. The External Authorizing Host 87 used for a positive authorization search is one that maintains secure information relating to informational elements and personal information of the HBS card. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the identification number 8 submitted. If the External Authorizing Host 87 finds a match, the host then will send back to the Internal Host 83 informational elements on file in the External Authorizing Host database 88 that correspond to the identification number 8 as well as any personal information that would place the person submitted in a negative file on the Internal Host database 83. This information may include but is not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the method 40 and place the identification number 8 in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to the identification number 8 submitted, the External Authorizing Host 88 will send a file not found notification to the Internal Host 83. The Internal Host 83 will then terminate the method 200 and place identification number 8 of the HBS card in a negative file.

If a negative authorization search yields no matches and a positive authorization yields a match with no red flag information, the electronic peripheral 75 further prompts the cardholder: what kind of transactional account would they like to delete—personal checking services, credit card services, debit card services, loyalty card services, and the like. The cardholder chooses checking services and is shown all checking accounts currently linked to their HBS card. The customer then chooses which checking account numbers they no longer wish to have ascribed to the HBS card. The choices are sent to the Internal Host 83 which then deletes the chosen checking service from the HBS card. The cardholder no longer has the ability to use the HBS card for the checking service just deleted.

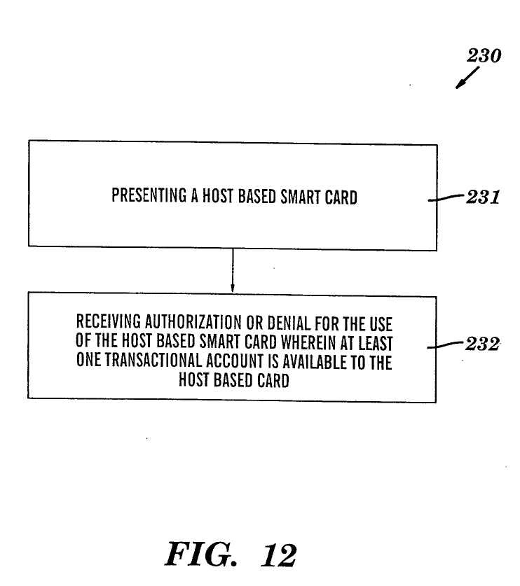

FIG. 12 depicts an embodiment of the present invention, a method 230 for purchasing goods and services using a Host Based Smart card comprising: a step 231, presenting a Host Based Smart card; a step 232, receiving authorization or denial for the use the Host Based Smart card wherein at least one transactional account is available to the Host Based Smart card. As shown in FIG. 4 and FIG. 12, the step 231 of the method 230, presenting the HBS card. An individual possessing the HBS card may approach a provider of goods and services for purchase of the goods and services. The cashier totals the bill and prompts the individual for payment. The individual then presents the HBS card for reconciliation of the bill.

As shown in FIG. 4 and FIG. 12, the step 232, an embodiment of the present invention focuses on receiving authorization or denial for the use the Host Based Smart card wherein at least one transactional account is available to the Host Based Smart card, wherein the transactional account available is a checking account.

The cardholder or cashier inserts the HBS card into an electronic peripheral 75. The electronic peripheral 75 reads the HBS card and obtains the informational elements from the card. The informational elements are sent to the Internal Host 83. The cashier then receives an authorization or denial from the Internal Host 83 for the individual to use their Host Based card with at least one transactional account available to the card. If an authorization is received by the cashier, the cashier then concludes the purchase by cashing out the POS system and the individual leaves with goods or services having been purchased. If a denial is received by the cashier, the cashier then voids the purchase and the individual leaves without any goods or services purchased.

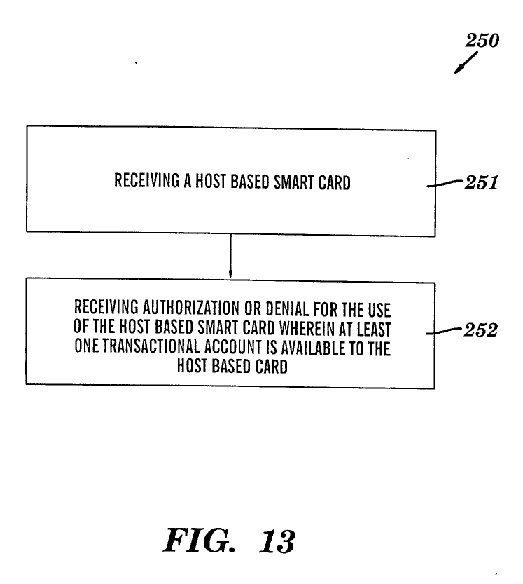

FIG. 13 depicts an embodiment of the present invention, a method 250 for selling goods and services via a Host Based Smart card comprising: a step 251, receiving a Host Based Smart card; and a step 252, receiving authorization or denial for the use the Host Based Smart card wherein at least one transactional account is available to the Host Based Smart card.

As shown in FIG. 4 and FIG. 13, the step 251 of the method 250, receiving the HBS card. A seller of goods and services possess equipment such as an electronic peripheral 75 that is able to receive the HBS card of an individual who wants to purchase goods and services from the seller of the goods and services. The seller totals the bill for goods and services to be purchased and prompts the individual for payment. The individual then presents the HBS card for reconciliation of the bill.

As shown in FIG. 4 and FIG. 13, the step 252, an embodiment of the present invention focuses on receiving authorization or denial for the use the Host Based Smart card wherein at least one transactional account is available to the Host Based Smart card, wherein the transactional account available is a checking account. The individual or the seller insert the HBS card received, from the step 251 of the method 250, into the electronic peripheral 75. The electronic peripheral 75 reads the magnetic stripe 21 or the bar code 22 on the HBS card to obtain the informational element, i.e. the number 8. The electronic peripheral 75 may also scan and capture the graphical representation of the individual 2 of the HBS card 1

Alternatively, it can be envisioned where the HBS card may have a data chip 23 imbedded within the body of the card. It is envisioned where the data chip 23 may contain informational elements such as the graphic representation of an individual 2; the residence information 3; the graphic representation of a fingerprint 4; the graphic representation of an individual's iris 5; the representation of an individual's DNA 6, the identification number 8, and the like. The data chip 23 may be read by an electronic peripheral 75 and similar devices.

Alternatively, the seller may receive informational elements from the HBS card via a radio frequency (RF) reader 76. An individual may pass their HBS card over a RF reader 76 which uses a RF transponder to activate the data chip 23 within the card 1. Informational elements such as the graphic representation of an individual 2; the residence information 3; the graphic representation of a fingerprint 4; the graphic representation of an individual's iris 5; the representation of an individual's DNA 6, the identification number 8, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, the seller may use wireless devices 77 such as cell phones; PDAs such as Palm Pilots®, Handspring Visor®, Handspring Treo®; and the like to receive the informational elements. Such devices could obtain the informational elements via scanning technology used to read the magnetic strip 21 or bar code 23, or have said informational elements manually inputted into said devices via physical or virtual keyboards.

Alternatively, the seller can receive the informational elements like the identification number 8, the address information 3, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

As shown in FIG. 4 and FIG. 13, the step 252, an embodiment of the present invention focuses on receiving authorization or denial for the use the Host Based Smart card wherein at least one transactional account is available to the Host Based Smart card, wherein the transactional account available is a checking account.

The informational elements are sent to the Internal Host 83. The Internal Host 83 then processes request. The seller then receives an authorization or denial from the Internal Host 83 for the individual to use their Host Based card with at least one transactional account available to the card. If an authorization is received by the seller, the seller then concludes the purchase by cashing out the POS system and the individual leaves with goods or services having been purchased. If a denial is received by the seller, the cashier then voids the purchase and the individual leaves without any goods or services purchased.

After the purchase is concluded, the checking account information such as the routing number, the account number, the check number, and the amount of the check are stored as a transaction file. The transaction files may be stored until a specified number of files have been accumulated. Once a predetermined number has been reached, the files then would be batched and sent to the Internal Host 83. The Internal Host 83 forwards the batched files to an Automated Clearing House (ACH) for account reconciliation.

Alternatively, after the purchase is concluded, the checking account information may be sent directly to the Internal Host 83 for storage as a transaction file. The Internal Host may 83 store the transaction files until a specified number of files have been accumulated. Once a predetermined number has been reached, the files then would be batched and sent to an Automated Clearing House (ACH) for account reconciliation. The following are definitions:

A government issued card as used herein is further defined as a card issued by a foreign government, an international body, an international organization, a foreign municipality and the like. The card issued by the foreign government may include but is not limited to passports, national identification cards, military cards, social security type cards, federal officer identification cards, federal employee cards, federal official cards, and combinations thereof. The card issued by the foreign municipality may include but is not limited to a driver's license, an approved non-driver identification card, a welfare card, a state officer identification card, a state employee card, a state official card, and the like.

A transactional account element as used herein is an identifier that is unique to the transactional account. The identifier is used to recognize or establish a particular transactional account and the owner or the identity of the transactional account holder. Transactional account elements include but are not limited to a representation of an individual, a representation of a fingerprint, a representation of an individual's iris, a representation of an individual's DNA, an account number, a representation of a retinal scan, a user address, a data chip, a molecular chip, a magnetic stripe, a bar code, and the like.

A transaction card is a physical representation of a transactional account. From herein, the term “transaction card” will be synonymous with the term “transactional account”. Examples of a transaction card include but are not limited to a credit card, a check, a debit card, a loyalty card, a membership card, and the like.

An incentive is defined as an expectation of reward that induces action to use or motivates to use a particular transactional account by an account holder. Examples include but are not limited a real-time purchase discount, a real-time generated coupon, loyalty card points, loyalty card credit, airline miles, rental car credit, proprietary reward programs, commercial reward programs, and combinations thereof.

A representation is a physical, a digital, an analog, and a visual or tangible rendering of someone or something.

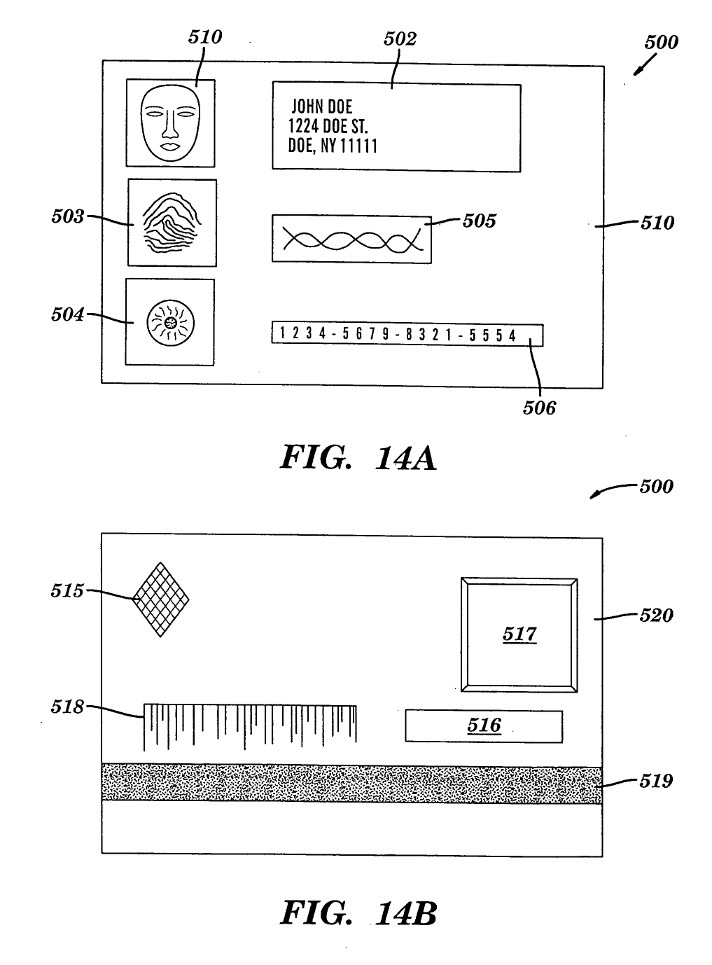

FIG. 14A a depicts a first face 510 of a transaction card 500 comprising transactional account elements: a representation of an individual 501; a residence information 502; a representation of a fingerprint 503; a representation of an individual's iris 504; a representation of an individual's DNA 505, and an account number 506.

FIG. 14B depicts a second face 520 of the transaction card 500 comprising: a magnetic stripe 519, a bar code 518, a data chip 517, a molecular chip 516, and a retinal scan 515.

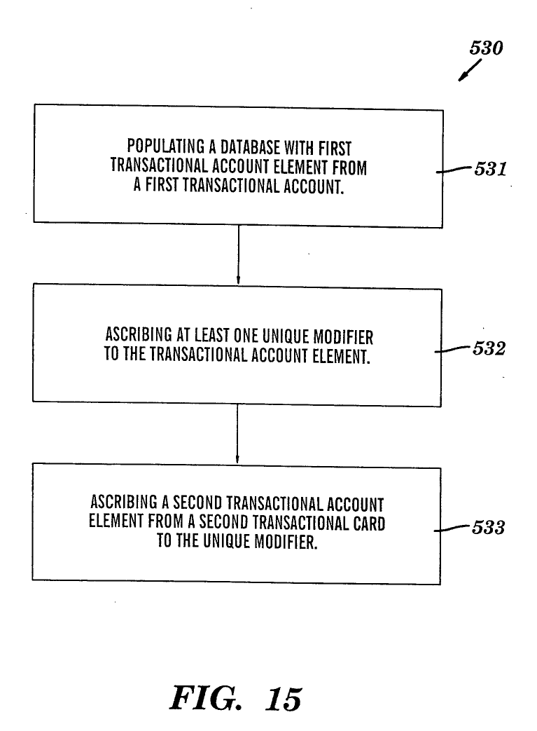

FIG. 15 depicts an embodiment of the present invention, a method 530 for a Host Based Smart (HBS) card comprising: a step 531, populating a database with a first transactional account element from a first transactional account; a step 532, ascribing at least one unique modifier to the first transactional account element; and a step 533, ascribing a second transactional account element from a second transactional account to the unique modifier.

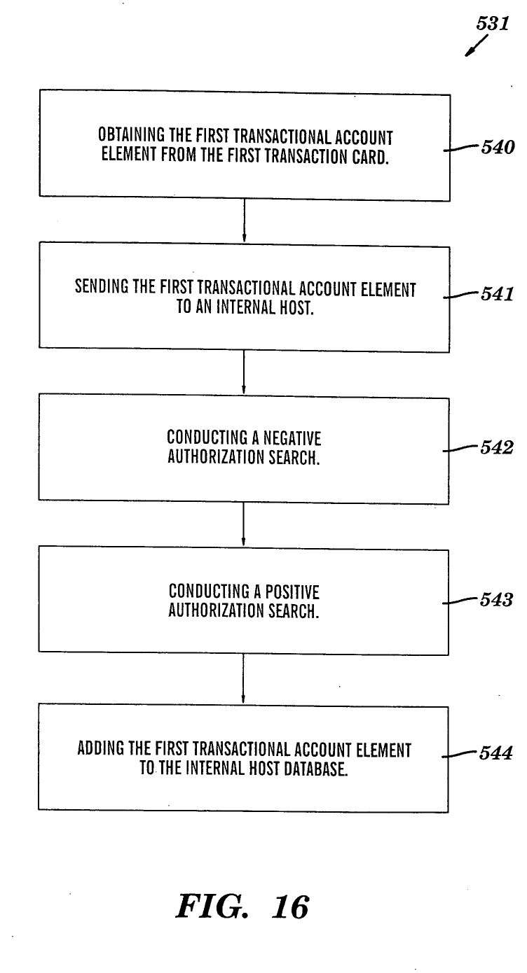

FIG. 16 depicts a flow chart of the step 531, populating a database with the first transactional account element from the first transaction card 500, of the method 530 of FIG. 15. Step 531 further comprises: a step 540, obtaining the first transactional account element from the transaction card 500; a step 541, sending the first transactional account element to an Internal Host; a step 542, conducting a negative authorization search; a step 543, conducting a positive authorization search; and a step 544, adding the first transactional account element to the Internal Host Database.

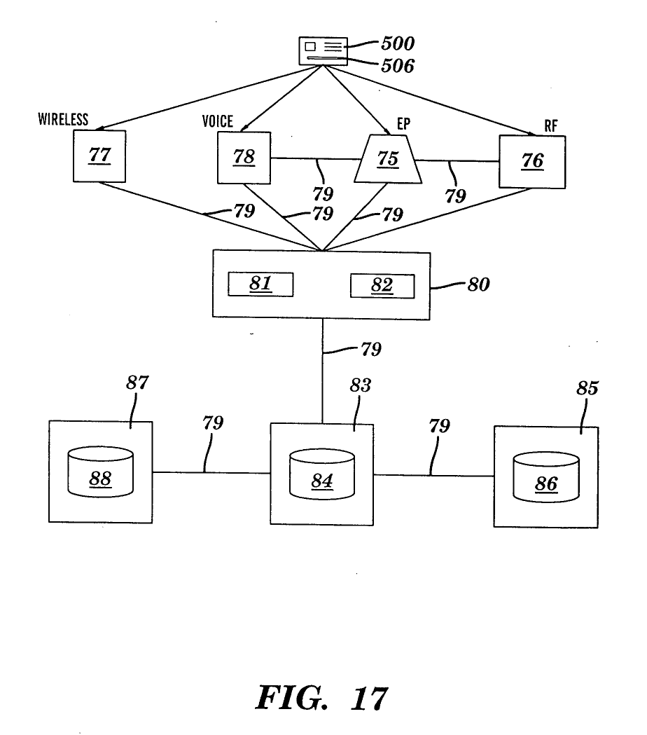

FIG. 17 depicts a system view of an embodiment of the present invention. As shown in FIG. 16 and FIG. 17, a step 531 of the method 530, one embodiment of the present invention focuses on populating a database with transactional account elements from the transaction card 500, wherein the transaction card 500 is a credit card and the transactional account element is an account number 506 of the card 500.

As shown in FIG. 16 and FIG. 17, the step 540, obtaining the first transactional account element from the credit card 500, of the step 531, the card 500 may be inserted into an electronic peripheral 75. The electronic peripheral 75 reads the magnetic stripe 519 or the bar code 518 on the credit card 500 to obtain the transactional account element, i.e. the account number 506. The electronic peripheral 75 may also scan and capture the representation of the individual 501 as well as capture the representation of the card 500.

Alternatively, it can be envisioned where the credit card 500 may have a data chip 517 imbedded within the body of the card 500. It also may be envisioned where the data chip 517 contains transactional account elements such as the representation of the individual 501; the residence information 502; the representation of the fingerprint 503; the representation of the individual's iris 504; the representation of the individual's DNA 505, the account number 506, and the like. The data chip 517 may be read by the electronic peripheral 75 and similar devices.

Alternatively, obtaining transactional account elements from the credit card 500 may be accomplished via a radio frequency (RF) reader 76. An individual may pass their card 500 over a RF reader 76 which uses a RF transponder to activate the data chip 517 within or on the card 500. Transactional account elements such as the representation of the individual 501; the residence information 502; the representation of the fingerprint 503; the representation of the individual's iris 504; the representation of the individual's DNA 505, the account number 506, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots®, Handspring Visor®, Handspring Treo®; and the like can be used to obtain the transactional account elements. Such devices could obtain the account elements via scanning technology used to read the magnetic strip 519 or the bar code 518, or have the account elements manually inputted into said devices via physical or virtual keyboards.

Alternatively, one can obtain the transactional account elements like the identification number 506, the address information 502, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The transactional account elements obtained by the electronic peripheral 75, the RF reader 76, wireless devices 77, and the voice recognition devices 78 may be temporarily stored in the server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79. Alternatively, for smaller companies and businesses, the Internal Host 83 may also function as the off-site server 82 as well as function as the Internal Host simultaneously.

As shown in FIG. 16 and FIG. 17 for points of illustration; the step 541, sending the transactional account element to the Internal Host 83, of the step 531, the account element obtained via step 540 is temporarily stored in the server 80, local 81 or off-site 82, may be sent to the Internal Host 83 from the server 80. The server 80 then sends the account element, the account number 506, to the Internal Host 83 via data transmission networks 79 wherein the account element is stored in the Internal Host database 84.

As shown in FIG. 16 and FIG. 17 for points of illustration; the step 542, conducting a negative authorization search, of the step 531, the Internal Host 83 may conduct a negative authorization search of the Internal Host database 84 by searching for a duplicate match of the account number 506 or a match to the account number 506 in a negative file. The negative file is a file that contains a transaction history of the individual that indicates whether the individual has unresolved financial issues that would not make them preferable for use of or membership to a HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the account number 506 submitted. If a match is found, the method 530 is terminated and the identification number 506 is placed in a negative file located in the Internal Host database 84. If a negative authorization search does not find a duplicate match or a match in a negative file, the method 530 is allowed to continue.

As shown in FIG. 16 and FIG. 17 for points of illustration; the step 543, conducting a positive authorization search, of the step 531, the Internal Host 83 sends the account number 506 of the credit card 500 to another External Authorizing Host 87 for a positive authorization search. The External Authorizing Host 87 used for a positive authorization search is one that maintains secure information relating to account elements and personal information of the credit card 500. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the account number 506 submitted. If the External Authorizing Host 87 finds a match, the host then will send back to the Internal Host 83 account elements on file in the External Authorizing Host database 88 that correspond to the account number 506 as well as any personal information that would potentially place the person submitted in a negative file on the Internal Host database 83. This information may include but is not limited to red flag information such as a stolen driver's license, a stolen transaction card, an illegal alien, a terrorist suspect, an international fugitive, a domestic fugitive, a member of the F.B.I. top ten wanted list, and the like.

Red flag information associated with the account number 506 will cause the Internal Host 83 to then terminate the method 530 and place the account number 506 in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to the account number 506 submitted, the External Authorizing Host 88 will send a file not found notification to the Internal Host 83. The Internal Host 83 will then terminate the method 530 and place account number 506 in a negative file.

As shown in FIG. 16 and FIG. 17 for points of illustration; the step 544, adding the first transactional account element to the Internal Host database 84, of the step 531, if a negative authorization search, of the step 542, yields no matches and a positive authorization search, of the step 543, yields a match with no red flag information, the Internal Host 83 then adds the transactional account element to the Internal Host database 84. The account element is stored as the account number 506 of the transaction card 500, specifically the credit card 500 account number 506. The steps 542 and 543, conducting a negative authorization search and a positive authorization search respectively, are interchangeable as well as any steps involving negative and positive authorization searches.

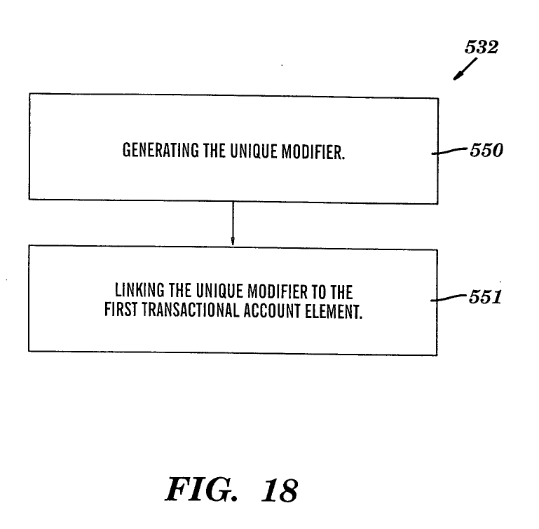

FIG. 18 depicts the step 532, ascribing at least one unique modifier to the transactional account element, of the method 530 of FIG. 15. Step 532 further comprises: a step 550, generating the unique modifier; and a step 551, linking the unique modifier to the first transactional account element. In an embodiment of the present, the transactional account element, the account number 506 of the transaction card 500; specifically the credit card number. As shown in FIG. 17 and FIG. 18, the step 550, generating the unique modifier, the Internal Host 83 generates the unique modifier via computer science methodology. The methodologies may include but art not limited to off-the-shelf retail software, in-house proprietary software, and the like. The unique modifiers generated may be numerical, alphabetic, symbolic, alpha-numeric, and combinations thereof.

As shown in FIG. 17 and FIG. 18, the step 551, linking the unique modifier to the first transactional account element, the Internal Host 83 links the unique modifier generated in the step 550 to the account element via computer science methodology. The methodologies may include but art not limited to off-the-shelf retail software, in-house proprietary software, and the like as well as combinations thereof. The account elements used are account elements that have been previously populated in the Internal Host database 84 by the step 531 of the method 530. The result of the steps 550 and 551 is the transactional account element having the unique modifier ascribed to the transactional account element. In this example, the unique modifier is ascribed to the credit card account number 506.

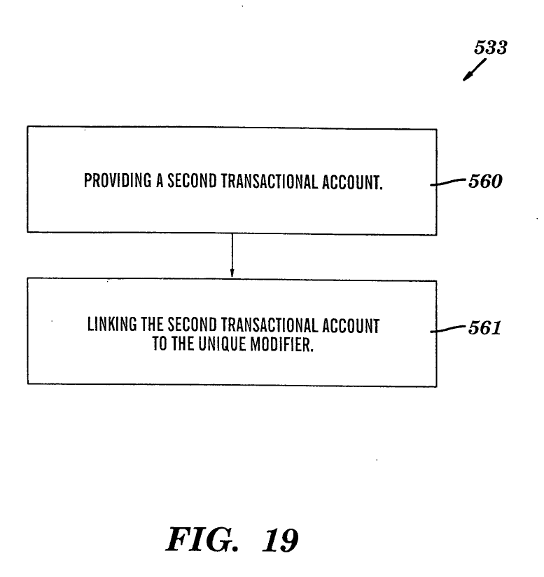

FIG. 19 depicts the step 533, ascribing a second transactional account element from a second transactional account to the unique modifier, of the method 530 of FIG. 15. Step 533 further comprises: a step 560, providing a second transactional account; and a step 561, linking the second transactional account to the unique modifier of step 550 of step 532 of the method 530.

As shown in FIG. 17 and FIG. 19, the step 560, one embodiment of the present invention focuses on providing the second transactional account wherein the second transactional account is a checking account. A check may be inserted into an electronic peripheral 75. The electronic peripheral 75 reads a Magnetic Ink Character Recognition (MICR) of the check to obtain account information, such as a routing number, a checking account number, and a check number. The electronic peripheral 75 may also scan and capture a representation of the check.

Alternatively, it can be envisioned where the check may have a data chip 517 imbedded or on the body of the check. It also is envisioned where the data chip 517 contains account information such as the representation of the check; the routing number; the checking account number; the check number, and the like. The data chip 517 may be read by an electronic peripheral 75 or similar devices.

Alternatively, obtaining checking account information from the check may be accomplished via a radio frequency (RF) reader 76. An individual may pass their check over a RF reader 76 which uses a RF transponder to activate the data chip 517 within the check. Checking account information such as the representation of the check; the routing number; the checking account number; the check number, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots®, Handspring Visor®, Handspring Treo®; and the like can be used to provide checking account information. Such devices could provide the account information via scanning technology used to read the MICR, or have the MICR manually inputted into said devices via physical or virtual keyboards.

Alternatively, one can provide checking account information such as the routing number; the checking account number, the check number, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The checking account information obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79.

The checking account information provided is temporarily stored in the server 80, local 81 or off-site 82, may be sent to the Internal Host 83 from the server 80. The server 80 then sends the checking account information to the Internal Host 83 via data transmission networks 79 wherein the checking account information is stored in the Internal Host database 84.

The Internal Host 83 may conduct a negative authorization search of the Internal Host database 84 by searching for a duplicate match of the checking account information or a match in a negative file. The negative file is a file that contains a transaction history of the individual that indicates whether the individual has unresolved financial issues that would not make them preferable for use of or membership to the HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checks and checking privileges, or any services related to financial transactional accounts; and that keeps records of the financial transactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the checking account number submitted. If a match is found, the step 533 is terminated and the account number is placed in a negative file located in the Internal Host database 84. If a negative authorization search does not find a duplicate match or a match in a negative file, the step 533 is continued.

The Internal Host 83 sends the checking account information to another External Authorizing Host 87 for a positive authorization search. The External Authorizing Host 87 used for a positive authorization search is one that maintains secure information relating to transactional accounts and personal information related to the transactional account. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the account number submitted. If the External Authorizing Host 87 finds a match, the host then will send back to the Internal Host 83 account information on file in the External Authorizing Host database 88 that correspond to the account number as well as any personal information that would place the person submitted in a negative file on the Internal Host database 83. This information may include but is not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the step 533 and place the checking account number in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to checking account number submitted, the External Authorizing Host 88 will send a file not found notification to the Internal Host 83. The Internal Host 83 will then terminate the step 533 and place the checking account number in a negative file. If a negative authorization search yields no matches and a positive authorization search yields a match with no red flag information, the Internal Host 83 then provides the checking account information to the Internal Host database 84.

As shown in FIG. 17 and FIG. 19, the step 561, one embodiment of the present invention focuses on linking the second transactional account to the unique modifier wherein the second transactional account is the checking account. The Internal Host 83 links the checking account number to the unique modifier previously ascribed to the first transactional account element, the credit card account number 506, that was used to populate the Internal Host Database 84 of the step 531 of the method 530.

The linking is accomplished via computer science methodology. The methodologies may include but art not limited to off-the-shelf retail software, in-house proprietary software, and the like. The second transactional account will be now ascribed to the informational element via the unique modifier and stored in the Internal Host database 84.

The results of the steps 531-533 of the method 530 is that the transaction card 500, specifically the credit card, is now effectively equivalent to or able to be used as the checking account, the second transaction card, and is afforded any associated checking privileges, i.e. a HBS card has been created through the method of having the checking account ascribed to the credit card via the unique modifier. The credit card can be used for limited check cashing privileges until a positive check cashing history has been achieved. Once the checking account has been ascribed to the credit card via the modifier, an individual no longer is required to present a check for checking privileges.

Limited check cashing privileges entail check velocity and check amount limits per week. For example, 2-3 checks may be written for the first three weeks without the aggregate sum not exceeding $300 per week. The second three weeks may include 3-5 checks without the aggregate sum not exceeding $600. Any number of variations of check velocity and check amount limits can be envisioned for developing a positive check cashing history. The more positive a customer's check cashing history is, the greater the check velocity and check amount limits can be.

Alternatively, other transactional accounts such as a loyalty card, a membership card, and the like may also be linked to the unique modifier. Once the transactional accounts of the aforementioned cards have been linked to the first transactional card 500, the other cards are no longer required to be presented for the use of services and privileges associated.

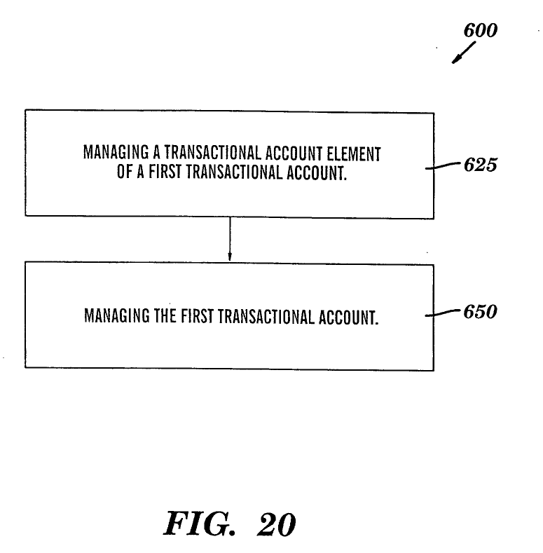

FIG. 20 depicts an embodiment of the present invention, a method 600 for system maintenance of the Host Based Smart (HBS) card comprising: a step 625, managing a transactional account element of a first transactional account; and a step 650 managing the first transactional account.

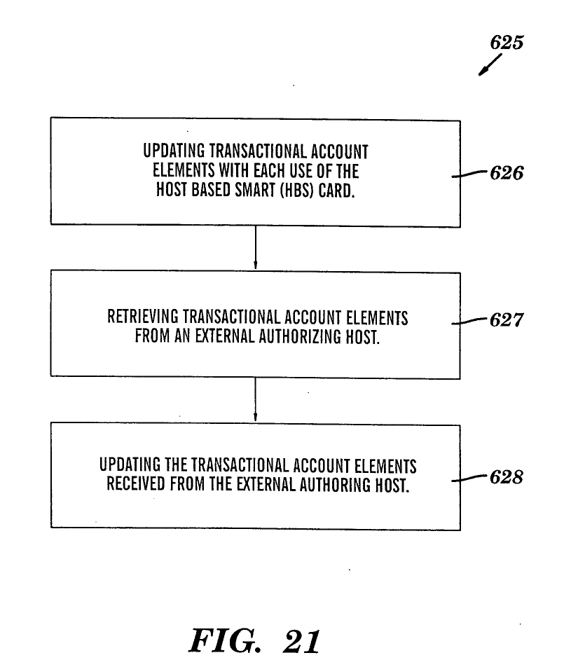

FIG. 21 depicts a flow chart of the step 625, managing transactional account element, of the method 600. The step 625 further comprises: a step 626, updating a first transactional account element with each use of the HBS card; a step 627, retrieving at least one transactional account element from an external authorizing host; and a step 628, updating the transactional account element in the Host database with the transactional element retrieved from the External Authorizing Host.

As shown in FIG. 17 and FIG. 21, the step 626, one embodiment of the present invention focuses on updating transactional account elements with each use of the HBS card, wherein the HBS card is a credit card. Each time the credit card is inserted into an electronic peripheral 75. The electronic peripheral 75 reads the magnetic stripe 519 or the bar code 518 on the HBS card to obtain the transactional account elements encoded in the magnetic stripe 519. The electronic peripheral 75 also scans and captures a representation of the credit card 500 and the informational elements on the card 500.

In an alternative embodiment, it can be envisioned where the credit card may have a data chip 517 imbedded within or on the body of the credit card 500. The data chip 517 would contain transactional account elements such as the representation of an individual 501; the residence information 502; the representation of the card holder fingerprint 503; the representation of the card holder's iris 504; the representation of the cardholder's DNA 6, the account number 506, and the like. The chip 517 may be read by an electronic peripheral 75 and similar devices.

In an alternative embodiment, obtaining transactional account elements from the credit card 500 may be accomplished via a radio frequency (RF) reader 76. An individual may pass their card 500 over a RF reader 76 which uses a RF transponder to activate the data chip 517 within or on the credit card 500. The account elements would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 76.

In an alternative embodiment, it can be envisioned that obtaining the transactional account elements from the credit card 500 may be accomplished via wireless devices 77 such as cell phones; PDAs such as Palm Pilots®, Handspring Visor®, Handspring Treo®; and the like. Such devices would obtain the account elements via scanning technology or have the account elements obtained via manually inputting the account elements into the devices via physical or virtual keyboards.

In an alternative embodiment, the transactional account elements may be obtained via voice recognition technology. Current voice recognition software and voice recognition devices 78 are able to transcribe voice into text for use by an electronic peripheral 75. The voice recognition devices 78 may be a stand alone unit that is connected to the electronic peripheral 75 via data transmission networks 79 or may be part of the electronic peripheral 75.

The transactional account elements obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79 may be temporarily stored in servers 17 connected to the aforementioned devices. The servers may be a local server 81, such as a POS or in-store server, or an off-site server 82, such as a retail headquarter or chain headquarter server, that is off-site but connected to the electronic peripheral 75, voice recognition devices 78, wireless devices 77, and RF readers 76 via data transmission networks 79.

The account elements provided are temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84.

The Internal Host 83 may conduct a negative authorization search of the Internal Host database 84 by searching for a duplicate match of the account information or a match in a negative file. The negative file is a file that contains a transaction history of the individual that indicates whether the individual has unresolved financial issues that would not make them preferable for use of or membership to the HBS card. The transactional account elements just obtained are compared to account elements previously used to populate the Internal Host database 84, of the step 531 of the method 530 of FIG. 15.

If the Internal Host 83 identifies any differences between the two sets of transactional account elements or discovers a new account elements that were not previously used to populate the Internal Host database 84, the Internal Host 83 will replace any old account elements on the Internal Host database 84 with the new account elements or add new account elements to the Internal Host database 84 that were not previously used to populate the Internal Host database 84.

As shown in FIG. 17 and FIG. 21, a step 627, retrieving transactional account elements from an External Authorizing Host 22, of the step 625 of the method 600, an embodiment of the present invention focuses on retrieving transactional account elements from an External Authorizing Host 84. The account element in this example is residence information 502 of the credit card holder.

The Internal Host 84 may randomly; on a predetermine schedule; by command of an Internal Host administrator; or with each use of the credit card 500 retrieve transactional account elements from an External Authorizing Host 87. The Internal Host 83 contacts the External Authorizing Host 87 via the data transmission network 79. The Internal Host 83 then sends the residence information 502 to the External Authorizing Host 88 for a positive authorization search. The External Authorizing Host 88 used is one that maintains secure information relating to transactional account elements and personal information of an individual. Examples of such External Authorizing agents include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches within the External Host database 88 for a positive match to the residence information 502 submitted. If the External Authorizing Host 88 finds a match, the host 88 then sends back to the Internal Host 84 the account elements that correspond to the residence information 502.

As shown in FIG. 17 and FIG. 21, a step 628, updating the transactional elements received from the External Authorizing Host 88, of the step 625 of the method 600. The account elements retrieved, of the step 627, are compared to the account elements previously used to populate the Internal Host database 84, of the step 531 of the method 530 of FIG. 15.

If the Internal Host 83 identifies any differences between the two sets of transactional account elements or identifies a new transactional account element that was not previously used to populate the Internal Host database 84, the Internal Host 83 will replace any old transactional account elements on the Internal Host database 84 with the new transactional account elements or add new account elements, submitted by the External Authorizing Host 87, in the Internal Host database 84 that were not previously used to populate the Internal Host database 84.

Updated account elements of the credit card pertaining to red flag information in nature may place the credit card in a negative file on the Internal Host's database 84. This information may include but is not limited to red flag information such as a stolen driver's license, an illegal alien, a terrorist suspect, an international fugitive, a domestic fugitive, a member of the F.B.I. top ten wanted list, stolen transactional accounts, and the like.

All red flag information associated with the credit card and related to national security will automatically create an exception file in the Internal Host database. The information may be sent real time or as a batch file later at predetermined time. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

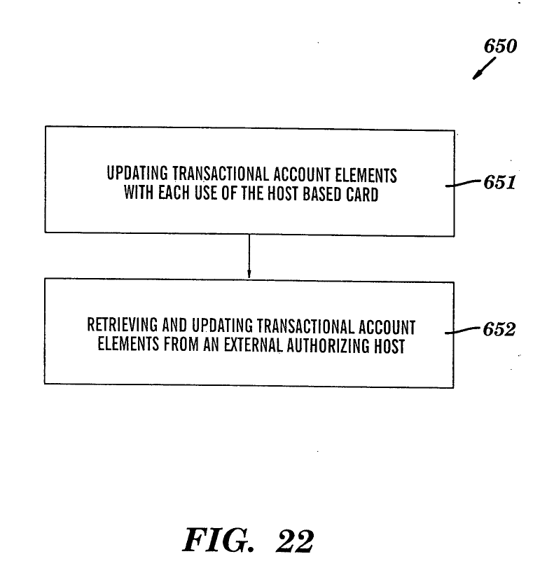

FIG. 22 depicts a flow chart of the step 650, managing at least one transactional account, of the method 600. The step 650 further comprises: a step 651, updating transactional account elements with each use of the HBS card; and a step 652, retrieving and updating transactional account elements from the External Authorizing Host.

As shown in FIG. 17 and FIG. 22; a step 651, updating transactional account information with each use of the HBS card, one embodiment of the present invention focuses on updating transactional account information wherein the transactional account is a credit card.

Each time the credit card 500 is inserted into an electronic peripheral 75. The electronic peripheral 75 reads the magnetic stripe 519 or bar code 518 on the card 500 to obtain the transactional account elements encoded in the magnetic stripe 519. The electronic peripheral 75 also scans and visually captures the transactional account elements on the card 500.

The account elements obtained are temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79 may be temporarily stored in a server 80 connected to the aforementioned devices. The server 80 may be a local server 81, such as a POS or in-store server, or an off-site server 82, such as a retail headquarter or chain headquarter server, that are off-site but connected to the electronic peripheral 75, voice recognition devices 78, wireless devices 77, and RF readers 76 via data transmission networks 79.

The account elements provided are temporarily stored in the server 80, local 81 or off-site 82, may be sent to the Internal Host 83 from the server 80. The server 80 then sends the account information to the Internal Host 83 via data transmission networks 79 wherein the account information, i.e. elements, is stored in an Internal Host database 84. The Internal Host 20 examines the aforementioned account elements and identifies the unique modifier that has been ascribed to them. Subsequently, all transactional accounts linked to the unique modifier are able to be identified. In this example, the credit card to be updated having a checking account linked to the unique modifier is identified.

The Internal Host 83 then conducts a negative search of the Internal Host database 84 by searching for a duplicate match of the checking account or a match of the checking account in a negative file. The negative file is a file that contains a transaction history of the consumer that indicates whether the consumer has unresolved financial issues that would not make them preferable for use of or membership to the HBS card. If a match is found, the use of the credit card 500 as a checking transaction is terminated and the checking account linked to the credit card 500 is placed in a negative file located in the Internal Host database 84. If a negative search does not find a duplicate match or a match in a negative file, the use of the credit card 500 for checking services and privileges remain.

As shown in FIG. 17 and FIG. 22; the step 652, retrieving and updating transactional accounts from an External Authorizing Host, of the method 600, one embodiment of the present invention focuses on updating transactional accounts wherein the transactional account is a checking account.

The Internal Host 83 may randomly, on a predetermine schedule, by command of an Internal Host administrator, or automatically with each use of the credit card 500 update transactional account information from the External Authorizing Host 85. The Internal Host 83 contacts the External Authorizing Host 85 via the data transmission network. The Internal Host 83 then sends the account number of the checking account to the External Authorizing Host 85 for a negative search. The External Authorizing Host 85 then looks within the External Host database 86 for a match in a negative file that may not be in the Internal Host database 84.

The External Authorizing Host 85 that is used for a negative search may be an institution that offers credit cards, debt cards, checking privileges, or any services related to financial transactions; and that keeps records of said financial transactions. Examples of such institutions include but are not limited to U.S. banks or international banks, the U.S. Treasury Department's Office of Foreign Asset Control, the Internal Revenue Service, the Department of Homeland Security, credit unions, consumer credit monitoring agencies, and the like.

The External Authorizing Host 85 searches within the External Host database 86 for a match, in a negative file, to the account number of the checking account submitted. If a match is found, the checking account that is linked to the credit card is placed in a negative file located in the Internal Host database 84, and the negative file is sent to the requesting server. If a negative search does not find a duplicate match or a match in a negative file, no updates are made to the transactional account.

The above example of the transactional account that was updated from an External Authorizing Host 86 was a a checking account. Alternative transaction accounts that may be updated from an External Authorizing Host 86 may include but are not limited to credit cards, debit cards, money management cards, and the like.

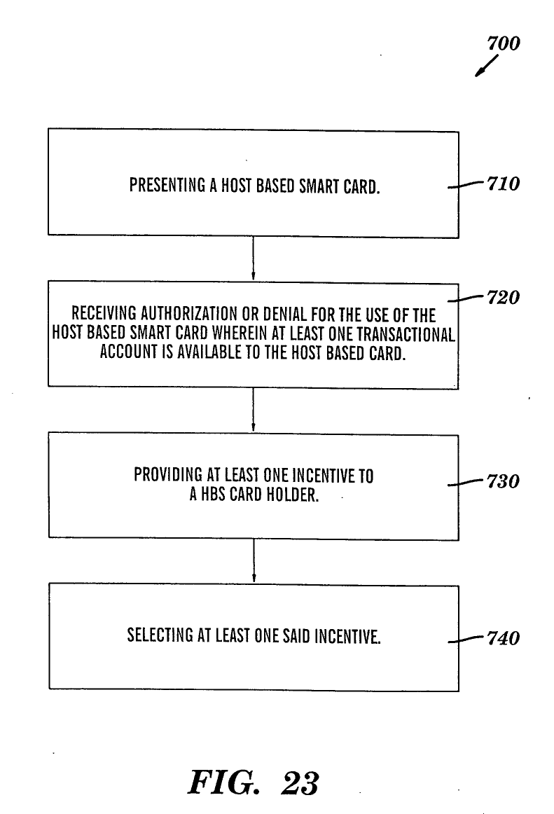

FIG. 23 depicts an embodiment of the present invention, a method 700 for purchasing goods or services using a Host Based Smart card comprising: a step 710, presenting the Host Based Smart card; a step 720, receiving authorization or denial for the use the Host Based Smart card wherein at least one transactional account is available to the Host Based Smart card; a step 730, providing at least one incentive to the HBS card holder; and a step 740, selecting at least one incentive.

As shown in FIG. 17 and FIG. 23, the step 710 of the method 700, presenting the HBS card. An individual possessing the HBS card may approach a provider of goods or services for purchase of the goods or services via the HBS card. The cashier totals the bill and prompts the individual for payment. The individual then presents the HBS card for reconciliation of the bill.

As shown in FIG. 17 and FIG. 23, the step 720, an embodiment of the present invention focuses on receiving authorization or denial for the use the Host Based Smart card wherein at least one transactional account is available to the Host Based Smart card. In the current example, the transactional account available is a checking account and the HBS card is a credit card 500.

The individual or the seller inserts the credit card 500 into the electronic peripheral 75. The peripheral 75 reads the magnetic stripe 21 or the bar code 22 on the credit card to obtain at least one transactional account element, i.e. the account number 506. The electronic peripheral 75 may also scan and capture the representation of the credit card 500 as well as the transactional account elements of the card 500.

Alternatively, it can be envisioned where the credit card 500 may have a data chip 23 imbedded within or on the body of the card 500. It is envisioned where the data chip 23 may contain account elements such as the representation of the cardholder 501; the residence information 502; the representation of the fingerprint 503; the representation of the cardholde's iris 504; the representation of the cardholder's DNA 505, the account number 506, and the like. The data chip 23 may be read by the electronic peripheral 75 and similar devices.

Alternatively, the seller may receive transactional account elements from the credit card 500 via a radio frequency (RF) reader 76. An individual may pass their credit card 500 over a RF reader 76 which uses a RF transponder to activate the data chip 23 within the card 500. Account elements such as the representation of the cardholder 501; the residence information 502; the representation of the cardholder's fingerprint 503; the representation of the cardholder's iris 504; the representation of the cardholder's DNA 505, the account number 506, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, the seller may use wireless devices 77 such as cell phones; PDAs such as Palm Pilots®, Handspring Visor®, Handspring Treo®; and the like to receive the informational elements. Such devices could obtain the account elements via scanning technology used to read the magnetic strip 21 or bar code 23, or have the account elements manually inputted into said devices via physical or virtual keyboards.

Alternatively, the seller can receive the account elements like the credit card 500 account number 506, the residence information 502, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The transactional account elements are sent to the Internal Host 83. The Internal Host 83 then processes the request. The seller then receives an authorization or denial from the Internal Host 83 for the cardholder to use their credit card 500 with at least one transactional account available to the card 500. If an authorization is received by the seller, the seller then concludes the purchase by cashing out the POS system and the cardholder leaves with goods or services having been purchased. If a denial is received by the seller, the cashier then voids the purchase and the individual leaves without any goods or services purchased or may attempt to use another transaction card or transactional account to reconcile the purchase via the methodology previously described.

As shown in FIG. 17 and FIG. 23, the step 730 of the method 700, an embodiment of the present invention focuses on providing at least one incentive to the HBS card holder. After authorization, the cardholder may be presented with a number of incentives via the POS system. The incentives offered may be from the HBS card used for the purchase or any incentives offered by transactional accounts that are linked to the HBS card via the method 530 of FIG. 15. For example if the HBS card is a credit card that has linked to it a transactional account being a Subway® card, the credit card holder may choose any incentives offered by the Subway card. Any transactional account or transactional card that is linked to the credit card and offers incentives may offer its incentives to the credit card holder.

As shown in FIG. 17 and FIG. 23, the step 740 of the method 700, an embodiment of the present invention focuses on selecting an incentive by the Host Based Smart card cardholder. The cardholder may select any incentive offered by the HBS card used to make the purchase or any transactional account or transactional card linked to the HBS card. This may be done by selecting the incentive option displayed by the POS system or presented by the cashier conducting the transaction. Furthermore, the cardholder may choose multiple incentives simultaneously if that option is allowed by the transactional accounts or transactional cards offering the incentives.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included withing the scope of this invention as defined by the accompanying claims.

1. A method for a Host Based Smart (HBS) card comprising:
populating a database with a first transactional account element from a first transactional account;
ascribing at least one unique modifier to said first transactional account element; and
ascribing a second transactional account element from a second transactional account to said at least one unique modifier.

2. The method of claim 1, wherein said first transactional account is a financial accommodation or financial service extended by said institution that permits said user the use of said financial accommodation or financial service towards the purchase of goods or services.

3. The method of claim 1, wherein said first transactional account is selected from a group consisting of a credit card, a check card, a debit card, a loyalty card, a checking account, a financial card, a membership card, a machine readable card, and combinations thereof.

4. The method of claim 1, wherein said second transactional account is a financial accommodation or financial service extended by said institution that permits said user the use of said financial accommodation or financial service towards the purchase of goods or services.

5. The method of claim 1, wherein said second transactional account is selected from a group consisting of a credit card, a check card, a debit, card, a loyalty card, a checking account, a financial card, a membership card, a machine readable card, and combinations thereof.

6. The method of claim 1, wherein said first transactional account element is an identifier used to recognize or establish said first transaction account element as belonging to said first transactional account.

7. The method of claim 1, further wherein said first transaction account element is an identifier used to verify the identity of the holder of said first transactional account.

8. The method of claim 1, wherein said first transactional account element is selected from a group consisting of an alphabetic character, a numeric character, an alpha-numeric character, a symbolic character, a bar code, a magnetic stripe, a data chip, a representation of a cardholder's fingerprint, a representation of a cardholder's iris, a representation of a cardholder's DNA, a representation of a cardholder's retinal scan, and combinations thereof.

9 The method of claim 8, wherein said representation is a physical, a digital, an analog, and a visual or tangible rendering of someone or something.

10. The method of claim 1, wherein said second transactional account element is an identifier used to recognize or establish said second transactional account element as belonging to said second transactional account.

11. The method of claim 1, further wherein said second transactional account element is an identifier used to verify the identity of the owner of said second transactional account.

12. The method of claim 1, wherein said second transactional account element is selected from a group consisting of an alphabetic character, a numeric character, an alpha-numeric character, a symbolic character, a bar code, a magnetic stripe, a data chip, a representation of a cardholder's fingerprint, a representation of a cardholder's iris, a representation of a cardholder's DNA, a representation of a cardholder's retinal scan, and combinations thereof.

13. The method of claim 12, wherein said representation is a physical, a digital, an analog, and a visual or tangible rendering of someone or something.

14. The method of claim 1, further comprising the step, generating said at least one unique modifier.

15. The method of claim 1, wherein said at least one unique modifier is selected from a group consisting of alphabetic characters, numeric characters, alpha-numeric characters, symbolic characters, and combinations thereof.

16. The method of claim 1, further comprising: linking said at least one unique modifier to said first transactional account element.

17. The method of claim 1, further comprising: linking said second transactional account to said at least one unique modifier.

18. A method of maintaining a Host Based Smart (HBS) card system comprising:
managing a transactional account element of a first transactional account; and
managing said first transactional account.

19. The method of claim 18, wherein said first transactional account is a financial accommodation or financial service extended by said institution that permits said user the use of said financial accommodation or financial service towards the purchase of goods or services.

20. The method of claim 18, wherein said first transactional account is selected from a group consisting of a credit card, a check card, a debit card, a loyalty card, a checking account, a financial card, a membership card, machine readable card, and combinations thereof.

21. The method of claim 18, wherein said transactional account element is an identifier used to recognize or establish said transactional account element as belonging to said first transactional account.

22. The method of claim 18, wherein said transactional account element is an identifier used to verify the identity of the owner of said transactional account.

23. The method of claim 18, wherein said transaction account element is selected from a group consisting of an alphabetic character, a numeric character, an alpha-numeric character, a symbolic character, a bar code, a magnetic stripe, a data chip, a representation of a user fingerprint, a representation of a user's iris, a representation of user's DNA, a representation of a user's retinal scan, and combinations thereof.

24. The method of claim 23, wherein said representation is a physical, a digital, an analog, and a visual or tangible rendering of someone or something.

25. A method for a Host Based Smart (HBS) card comprising:
populating a database with a first transactional account element from a first transactional account or a first informational element from a first government issued card;
ascribing at least one unique modifier to said first transactional account element or said first informational element; and
ascribing a second transactional account element or a second government issued card to said unique modifier.

26. The method of claim 25, wherein said first transactional account is a an accommodation or service extended by an institution that permits a user the use of said accommodation or service towards the purchase of goods or services.

27. The method of claim 25, wherein said first transactional card is selected from a group consisting of a credit card, a check card, a debit, card, a loyalty card, a checking account, a financial card, a membership card, a machine readable card, and combinations thereof.

28. The method of claim 25, wherein said second transactional account is an accommodation or service extended by an institution that permits a user the use of said accommodation or service towards the purchase of goods or services.

29. The method of claim 25, wherein said second transactional account is selected from a group consisting of a credit card, a check card, a debit, card, a loyalty card, a checking account, a financial card, a membership card, a machine readable card, and combinations thereof.

30. The method of claim 25, wherein said first government issued card is selected from a group consisting of cards issued by a federal, a state, a municipal government, an international government, and combinations thereof.

31. The method of claim 30, wherein said issued card is a passport, national identification card, military card, social security card, federal officer identification card, federal employee card, federal official card, an approved non-driver identification card, welfare card, state officer identification card, state employee card, state official card, municipal officer identification card, municipal employee card, a state official card, and the like.

32. The method of claim 25, wherein said first transactional account element is an identifier used to recognize or establish said first transactional account element as belonging to a holder of said first transactional account.

33. The method of claim 25, further wherein said first transactional account element is an identifier used to verify the identity of the owner of said first transactional account.

34. The method of claim 33, wherein said first transactional account element is selected from a group consisting of an alphabetic character, a numeric character, an alpha-numeric character, a symbolic character, a bar code, a magnetic stripe, a data chip, a representation of a cardholder's fingerprint, a representation of a cardholder's iris, a representation of a cardholder's DNA, a representation of a cardholder's retinal scan, and combinations thereof.

35. The method of claim 34, wherein said representation is a physical, a digital, an analog, and a visual or tangible rendering of someone or something.

36. The method of claim 25, wherein said informational element is an identifier used to recognize or establish said government issued card as belonging to a particular individual and to verify the identity of the individual and wherein the informational element is a graphic representation of an individual, a graphic representation of a fingerprint, a graphic representation of an individual's iris, a representation of an individual's DNA, an identification number, a retinal scan.

37. A method for purchasing goods or services using a Host Based Smart (HBS) card comprising:
presenting a HBS card;
receiving authorization or denial for the use of said HBS card wherein at least one transactional account is available to said HBS card;
providing at least one incentive to a HBS card holder; and
selecting said at least one incentive.

38. The method of claim 37, wherein said at least one transactional account is an accommodation or financial service extended by said institution that permits said user the use of said financial accommodation or financial service towards the purchase of goods or services.

39. The method of claim 37, wherein said at least one incentive is selected from a group consisting of a real-time purchase discount, a coupon for a future purchase, loyalty card points, a loyalty card credit, airline miles credit, rental car credit, commercial reward programs, proprietary reward programs, and combinations thereof.
